(19) United States
(12) Patent Application Publication
(10) Pub. No.: US 2005/0102177 A1
(43) Pub. Date: May 12, 2005

(54) Advertisement delivery method and system

(76) Inventor: Hiromitsu Takayama, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 10/652,315

(22) Filed: Sep. 2, 2003

(30) Foreign Application Priority Data
Sep. 2, 2002 (JP) 2002-256293
Aug. 21, 2003 (JP) 2003-297981

(51) Int. Cl. G06F 17/60

(52) U.S. Cl. 705/14

(57) ABSTRACT

In an Internet banner advertisement, a banner advertisement only selected by the user is extracted and displayed so that convenience for the advertisement sender side and convenience of a user's information collection are provided simultaneously. An advertisement delivery server transmits advertising area display information allowing a client terminal to display banner advertisements in an advertising area and, at the same time, it transmits category selection screen information for the client terminal to display a category selection screen for selecting categories of advertisements. The client terminal displays banner advertisements in the advertising area and, at the same time, it displays the category selection screen. When categories are selected in the category selection screen, the client terminal transmits the categories selected to an advertisement delivery server. The advertisement delivery server extracts banner advertisements that belong to the selected categories received from the client terminal, and it transmits the banner advertisements to the client terminal. The client terminal updates the banner advertisements in the advertising area.

### BACKGROUND OF THE INVENTION

1. Field of the Invention

The present invention relates to an advertisement delivery system and method on internet, advertisement delivery server, and client terminal for displaying banner advertisements, and in particular, to those that can extract and display banner advertisements only of categories which the user has interests in.

2. Description of the Background Art

For advertisement on Internet, banner advertising is popularly used as shown, for example, in Japanese Laid Open Patent Publication No. 2001-188730. A banner advertisement is a graphical image 202 of a specified shape (for example, rectangle) on Internet Web page 201 as shown in FIG. 34(A), and in this banner image 202, characters and graphics (banner images) of company names and product names of advertisers are illustrated, and at the same time, tags for linking to servers of each advertiser are embedded. Clicking on the banner images 202, as shown in FIG. 34(B), is able to take the user to advertiser's web page 205. However, this kind of conventional banner advertising is delivered indiscriminatingly from advertisers, or advertisers judge characteristics of individual users and deliver advertisements that would suit to the users.

Banner advertising by conventional techniques is not provided by making the best of interactivity, which is the basic feature of communications using communication networks, but is primarily based on the intension of the advertisement delivery side with convenience of advertisers taken into account. It is said to judge features of individual users and delivery advertisements that would suit to their feature, but this is first and foremost based on the judgment of advertising delivering side, and because to achieve this, matters related to user privacy must be brought up to advertisers, it contains problems of spillage of privacy information.

In conventional banner advertising, users were unable to take initiative to search for information, which is the basic feature of information collecting means on communication networks. That is, users were unable to see banner advertisements of categories which users desire one after another and collect information.

Today, while refurbishment of communication network is taking place, an advertisement delivery system that is suitable for the new age is being awaited. The conventional banner advertisement is an advertisement delivery system based on the way of advertising before the communication network emerges, and is based on the logic same as that of advertisement delivery of mass media, and does not go beyond the bounds of that logic and remains old-fashioned. Therefore, it is requested for an advertisement delivery system that it considers not only the convenience on the advertisement delivery side but also user's information collecting means.

### SUMMARY OF THE INVENTION

It is therefore an object of the present invention to provide an advertisement delivery system and method, advertisement delivery server, and client terminal which can simultaneously provide the convenience of advertisers and convenience as user information collecting means in the light of the above problems.

To solve the above-mentioned problems, the advertisement delivery method of the present invention is characterized in that in an advertisement delivering method for displaying advertising screen information with information of URL to be linked embedded in the screen, an advertisement delivery server transmits advertising area display information for displaying an advertising area containing advertising screen information on the client terminal and at the same time transmits category selection screen information for selecting advertisement categories, a client terminal receives the advertising area display information from the advertisement delivery server, displays the advertising area containing the advertising screen information based on the relevant received advertising area display information, and at the same time displays the category selection screen based on the relevant received category selection screen information, and transmits the selected category information to the advertisement delivery server when any category is selected by the category selection screen, the advertisement delivery server receives the selected category information from the client terminal, extracts the advertising screen information that belongs to the selected category based on the selected category information, and sends the selected category information to the client terminal, and the client terminal receives the advertising screen information that belongs to the selected category and updates the advertising screen information in the advertising area.

In the advertisement delivery method according to present invention, the category selection screen is preferably displayed by pressing a control button displayed on the advertising area.

In the advertisement delivery method according to present invention, relevant information derived from the selected category information is preferably stored in the advertisement delivery server.

In the advertisement delivery method according to present invention, relevant information derived from the selected category information is preferably stored in the client terminal.

In the advertisement delivery method according to present invention, the relevant information is preferably a relation between the user information the selected category information.

In the advertisement delivery method according to present invention, the relevant information is preferably generated based on a relation between the user information and the advertising screen information that belongs to the selected category.

In the advertisement delivery method according to present invention, the advertising area is preferably updated by updating the whole advertising area including the advertising screen information.

In the advertisement delivery method according to present invention, the advertising area is preferably updated by updating the portion of the advertising screen information in the advertising area including the advertising screen information.

The advertisement delivery system of the present invention is characterized in that an advertisement delivery system for displaying advertising screen information with the information of the advertiser's web page to be linked embedded in the screen comprises an advertisement delivery server comprising a delivered advertising screen information storage section for storing advertising screen information consisting of advertising image and information showing a relation between the advertisement category and the advertisement screen information belonging to the advertisement category, and advertiser's web page information to be linked embedded in the advertising image, an advertising area information generating section for generating advertising area display information, and a category screen information generating section for generating category selection screen information, a client terminal comprising a display section for displaying the advertising area containing the advertising screen information based on the advertising area display information received from the advertisement delivery server and at the same time for displaying a category selection screen based on the category selection screen information received from the advertisement delivery server, and an input section for selecting the category, and a network for connecting the advertisement delivery server to the client terminal, and the advertisement delivery server transmits the advertising area display information for allowing the client terminal to display an advertising area containing the advertising screen information and at the same time transmits the category selection screen information for allowing the client terminal to display a category selection screen, the client terminal receives the advertising area display information from the advertisement delivery server, displays the advertising area containing the advertising screen information based on the advertising area display information received and at the same time receives the category selection screen information from the advertisement delivery server, displays category selection screen based on the category selection screen information received, and transmits the selected category information to the advertisement delivery server when any category is selected from the category selection screen, the advertisement delivery server receives the selected category information from the client terminal, extracts the advertising screen information that belongs to the selected category, and transmits the advertising screen information to the client terminal, and the client terminal receives the advertising screen information that belongs to the selected category and updates the advertising screen information in the advertising area.

The advertisement delivery server of the present invention comprises a delivered advertising screen information storage section for storing advertising screen information consisting of an advertising image and the advertiser's web page to be linked embedded in the advertising image and information showing a relation between the advertisement category and the advertisement screen information belonging to the advertisement category, an advertising area information generating section for generating advertising area display information, and a category screen information generating section for generating category selection screen information in an advertisement delivery server of an advertisement delivery system in which advertising screen information with information of the advertiser's web page to be linked embedded in the screen is displayed in the screen, wherein the advertising area display information for displaying an advertising area containing the advertising screen information is transmitted to the client terminal and at the same time category selection screen information for displaying a category selection screen, and the advertising screen information that belongs to the selected category information is extracted and transmitted to the client terminal based on the selected category information when selected category information is received from the client terminal.

In the advertisement delivery server according to the present invention, a category information storage section is preferably further equipped to store user information and corresponding selected category information.

In the advertisement delivery server according to the present invention, an advertising screen information storage section is preferably further equipped to store user information and corresponding advertising screen information that belongs to the selected category.

A client terminal of the present invention comprises a display section for displaying a screen of an advertising area containing advertising screen information as well as displaying a category selection screen, and an input section for selecting the category, wherein when advertising area display information for displaying an advertising area containing advertising screen information is received from an advertisement delivery server, the advertising area containing the advertising screen information is displayed based on the advertising area display information received, and when category selection screen information for displaying a category selection screen is received from the advertisement delivery server, a category selection screen is displayed based on the category selection screen information received, and when the categories are selected by the input means, the selected category information is transmitted to the advertisement delivery server, and when advertising screen information that belongs to the selected categories are received from the advertisement delivery server, the advertising screen information in the advertising area is updated.

In the client terminal according to the present invention, a category information storage section is further equipped to store the selected category information.

In the client terminal according to the present invention, an advertising screen information storage section is preferably further equipped to store the advertising screen information that belongs to the selected category.

### EFFECTS OF THE INVENTION

According to the advertisement delivery method and delivery system, the advertisement delivery server transmits advertising area display information for displaying an advertising area containing advertising screen information to a client terminal as well as transmits category selection screen information for displaying a category selection screen for selecting a category of advertisement, and the client terminal receives the advertising area display information from the advertisement delivery server and displays the advertising area containing advertising screen information based on the received advertising area display information, and at the same time, receives the category selection screen information and displays the category selection screen based on the received category selection screen information, and when the category is selected by the category selection screen, the client terminal transmits the selected category information to the advertisement delivery server, and the advertisement delivery server receives the selected category information from the client terminal, extracts advertising screen information that belongs to the selected category and transmits the advertising screen information to the client terminal, and the client terminal receives the advertising screen information that belongs to the selected category, and updates the advertising screen information in the advertising area based on the received advertising screen information.

By this, it is possible to select the category which the user is interested in and to provide the banner advertisement of the category of user's interest. The user sees this banner advertisement and if she/he find any banner advertisement of his/her interest, she/he clicks the banner image of the banner advertisement. And clicking on the banner image is able to take the user to the web page of the company whose URL is embedded in the banner image. By this, the individual user can receive the banner advertisement of the category only she/he desires. In addition, the user selects the category of advertisement she/he desires, immediately reflects the results to the banner advertisement contents for the next time, and can receive the banner advertisement only of the category which she/he selects.

As described above, it is possible for the user to select the category which she/he is interested in, and to extract and provide the banner advertisement of the category only of the user's interest. This will bring profit to both sides, advertiser who posts the banner advertisement and the user who views the banner advertisement. That is, on the user side who views the banner advertisement, she/he can narrow down banner advertisements of the category of his/her interest only and can positively utilize the banner advertisement as information collecting sources. On the company side, the advertiser who posts the banner advertisement can catch customers who are interested in their products and can expect to increase the advertisement effects of the product.

According to the advertisement delivery method of the present invention, relevant information derived from the selected category information is preferably stored in the advertisement delivery server. Or, more preferably, relevant information derived from the selected category information is stored in the client terminal.

By this, when the user presses a reload button, banner advertisements of the category which the user has select are updated one after another. When the user accesses the advertisement delivery server, banner advertisements only of the category which the user has selected are extracted and displayed even if the user does not select the category.

According to the advertisement delivery server of the present invention, in an advertisement delivery server of an advertisement delivery system which displays advertising screen information with information hyperlinked to the URL of the advertiser's web page embedded in the screen, comprising a delivered advertising screen information storage section for storing advertising screen information comprising an advertising image and advertiser's web page embedded in the advertising image and information showing a relation between the advertisement category and the advertising screen information belonging to the advertisement category, an advertising area information generating section for generating advertising area display information, and a category screen information generating section for generating category selection screen information, the advertisement delivery server transmits the advertising area display information for displaying the advertising area containing the advertising screen information to the client terminal as well as transmits the category selection screen information for displaying the category selection screen, and when the selected category information is received from the client terminal, extracts the advertising screen information which belongs to this selected category based on the selected category information and transmits the advertisement screen information to the client terminal.

By this, it is possible to select the category which the user is interested in and to provide banner advertisements only of the category of the user's interest. The user views the banner advertisements and if there is any banner advertisement which she/he is interested in, she/he clicks the banner image of the banner advertisement, and clicking on the banner image is able to take the user to the advertiser's web page whose URL is hyperlinked to the banner image.

According to the advertisement delivery server of the present invention, a category information storage section is preferably further equipped to store the selected category information and the user information in correspondence with the selected category information. Or an advertisement screen information storage section is further preferably equipped to store the advertising screen information which belongs to the selected category and the user information in correspondence with the advertising screen information which belongs to the selected category.

By this, when the user presses a reload button, banner advertisements of the category which the user has selected are updated one after another. When the user accesses the advertisement delivery server, banner advertisements only of the category which the user has selected are extracted and displayed even if the user does not select the category.

According to the client terminal of the present invention, which comprises a display section for displaying a screen of advertising area containing advertising screen information as well as for displaying a category selection screen, and an input section for selecting the category, when the client terminal receives advertising area display information for displaying an advertising area containing advertising screen information from the advertisement delivery server, the client terminal displays a screen of advertising area containing advertising screen information, and when the client terminal receives category selection screen information for displaying the category selection screen from the advertisement delivery server, the client terminal displays the category selection screen based on the selected category selection screen information received, and when a category is selected by the input means, the client terminal transmits the selected category information to the advertisement delivery server, and when the client terminal receives the advertising screen information which belongs to the selected category from the advertisement delivery server, the client terminal updates the advertising screen information in the advertising area based on the received advertising screen information.

By this, the user can select the category which she/he is interested in and can receive banner advertisements of the category of the user's area. It is possible to achieve a system in which the user views this banner advertisement, and if she/he finds any banner advertisement of his/her interest, the user clicks the banner image of the banner advertisement, and clicking on the banner image is able to take the user to the advertiser's web page of the URL hyper-linked to the banner image.

According to the client terminal of the present invention, a category information storage section can be further equipped to store the selected category information. Or, an advertising screen information storage section can be further equipped to store the advertising screen information which belongs to the selected category.

By this, when the user presses a reload button, banner advertisements of the category which the user has selected are updated one after another. When the user accesses the advertisement delivery server, banner advertisements only of the category which the user has selected are extracted and displayed even if the user does not select the category.

### BRIEF DESCRIPTION FOR THE DRAWINGS

FIG. 1 is a block diagram showing the network configuration of an advertisement delivery system according to the present invention;

FIG. 2 is an explanatory diagram used for explaining advertisement delivery in the advertisement delivery system according to the present invention;

FIG. 3 is an explanatory diagram used for explaining advertisement delivery in the advertisement delivery system according to the present invention;

FIG. 4 is an explanatory diagram of one example of an advertisement display screen in the advertisement delivery system according to the present invention;

FIG. 5 is an explanatory diagram of one example of an advertisement display screen in the advertisement delivery system according to the present invention;

FIG. 6 is an explanatory diagram of another example of an advertisement display screen in the advertisement delivery system according to the present invention;

FIG. 7 is an explanatory diagram of another example of an advertisement display screen in the advertisement delivery system according to the present invention;

FIG. 8 is an explanatory diagram of still another example of an advertisement display screen in the advertisement delivery system according to the present invention;

FIG. 9 is a block diagram of the first embodiment of the present invention;

FIG. 10 is a sequence diagram used for explaining the first embodiment of the present invention;

FIG. 11 is an explanatory diagram of one example of banner database;

FIG. 12 is an explanatory diagram of the other example of banner database;

FIG. 13 is an explanatory diagram of one example of category ID/advertisement ID database;

FIG. 14 is an explanatory diagram of the other example of category ID/advertisement ID database;

FIG. 15 is an explanatory diagram of generating advertising area information;

FIG. 16 is an explanatory diagram of one example of banner database with category;

FIG. 17 is an explanatory diagram of the other example of banner database with category;

FIG. 18 is a block diagram of the second embodiment of the present invention;

FIG. 19 is an explanatory diagram of one example of user ID/category ID database;

FIG. 20 is an explanatory diagram of the other example of user ID/category ID database;

FIG. 21 is a sequence diagram used for explaining the second embodiment of the present invention;

FIG. 22 is a block diagram of the third embodiment of the present invention;

FIG. 23 is an explanatory diagram of one example of user ID/advertisement ID database;

FIG. 24 is an explanatory diagram of the other example of user ID/advertisement ID database;

FIG. 25 is a sequence diagram used for explaining the third embodiment of the present invention;

FIG. 26 is a block diagram of the fourth embodiment of the present invention;

FIG. 27 is an explanatory diagram of one example of the selected category ID information;

FIG. 28 is a sequence diagram used for explaining the fourth embodiment;

FIG. 29 is a block diagram of the fifth embodiment of the present invention;

FIG. 30 is an explanatory diagram of one example of the selected advertisement ID information;

FIG. 31 is a sequence diagram used for explaining the fifth embodiment;

FIG. 32 is a sequence diagram used for explaining when the advertising area display information is sent to the client terminal by digital broadcasting in the present invention;

FIG. 33 is a sequence diagram used for explaining when URL of the advertising area is sent to the client terminal by digital broadcasting in the present invention; and

FIG. 34 is an explanatory diagram of a conventional banner advertisement.

### DETAILED DESCRIPTION OF THE PREFERRED EMBODIMENTS

Overview of the Advertisement Delivery System:

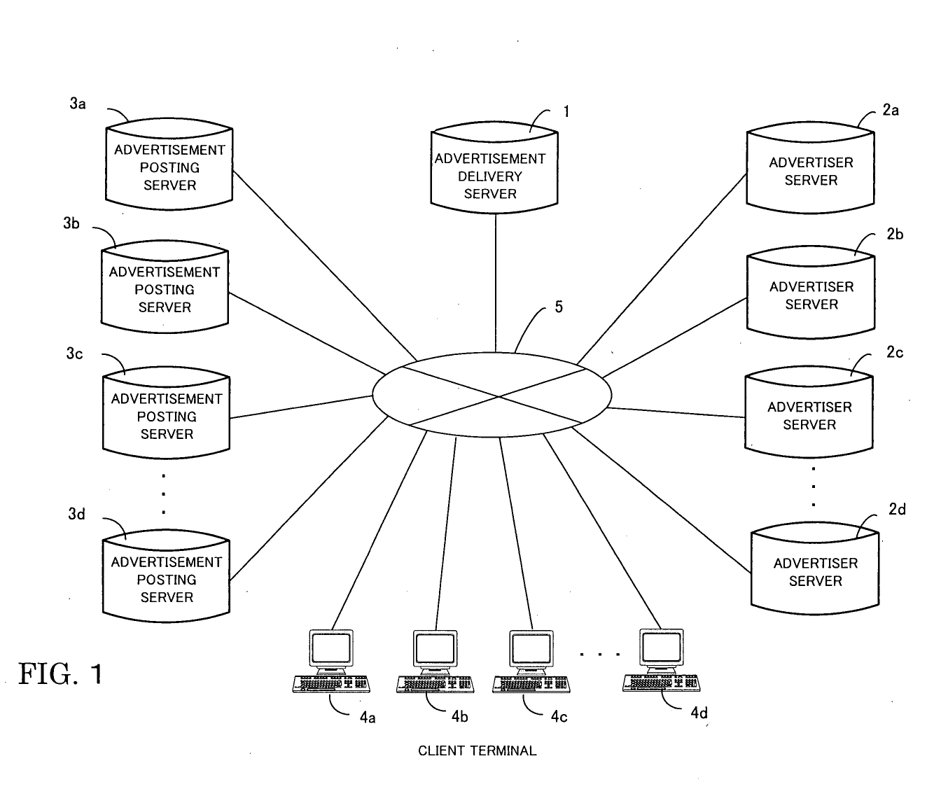

Referring now to the drawings attached, embodiments of the present invention will be described in detail as follows. FIG. 1 shows an overview of an advertisement delivery system with the present invention applied. In FIG. 1, advertisement delivery server 1 is an advertisement delivery server for providing advertisement in the form of banner advertising on a web page. Banner advertising is positioned on an advertising area of a specified shape on an Internet web page, and indicates characters, graphics, etc. of company name and product name of the advertiser, and embeds a tag for linking to each of advertiser servers 2a, 2b, 2c, . . . , 2d in the banner.

The substance of banner advertising contents comprises banner image information for displaying characters and graphics for forming an advertisement of a specified shape and address information (URL: Uniform Resource Locator) of the advertiser web page to be linked embedded in the banner image. Examples of the banner image include not only images with advertisement characters and graphics marked down but also other methods, for example, applet by JAVA (trademark) language or flash animations by Flash (trademark), etc.

Furthermore, in advertisement delivery server 1 with the present invention applied, banner advertisements of categories which the user desires only can be extracted and presented on the web page. By this, the user who views web pages on Internet can more positively utilize banner advertising while narrowing down banner advertising in the category which the user is interested in.

Companies, etc. who desire to post banner advertising on web pages using advertisement delivery server 1 execute agreements with an operator of advertisement delivery server 1 and become advertiser. Advertiser servers 2a, 2b, 2c, . . . , 2d are servers of advertiser web pages. In advertisers' web pages, information on products of each company and company's activity conditions are provided. For example, if the advertiser is an automaker, on the web page, model names, performance, prices, distributors, and other information of automobile produced by the company are posted.

And a web-page operator who hopes to post company banner advertising on his/her web page using advertisement delivery server 1 executes agreements of the operator of advertisement delivery server 1. Advertisement posting servers 3a, 3b, . . . 3d are servers of web pages with banner advertising posted by executing agreements with the operator of advertisement delivery server 1.

Client terminals 4a, 4b, 4c, . . . , 4d are terminals of users who use Internet. Specific examples of the display section of client terminals 4a, 4b, 4c, . . . , 4d include a personal computer display, PDA (Personal Digital Assistant) display, cellular phone display, ATM (Automatic Teller Machine) display, HMD (Head Mount Display), goggles with display, TV receiver display, large-size display, projection screen, or stereoscopic equipment system combining the surround-screen projection-based virtual reality system such as CAVE (trademark) with LCD strobe glasses, etc. Examples of the entry section of client terminals 4a, 4b, 4c, . . . , 4d include mouse, joystick, entry pen, data glove, space ball, TV receiver remote controller, etc.

To this client terminal 4a, 4b, 4c, . . . , 4d, an access application program called browser is installed. By this browser, text, image, voice, etc. are linked by the protocol such as HTTP (Hyper Text Transfer Protocol), etc. from the information described in the hyperlink language such as HTML, CHTML, BML, XHTML, etc.

These advertisement delivery server 1, advertiser server 2a, 2b, 2c, . . . , 2d, advertisement posting server 3a, 3b, . . . , client terminal 4a, 4b, 4c, . . . , 4d are linked to Internet 5, respectively, which is a communication network. By the way, the communication networks other than Internet 5 may be used, such as Intranet, cable net for CATV (Cable Television), general WAN (Wide Area Network), and other communication networks. The system may be of a closed circuit or wireless system, or combination of both. In addition, broadcasting may be included as part of transmission functions of communication networks. In practicing the invention, the client terminal may receive the first advertising area display information from the broadcasting station by broadcasting.

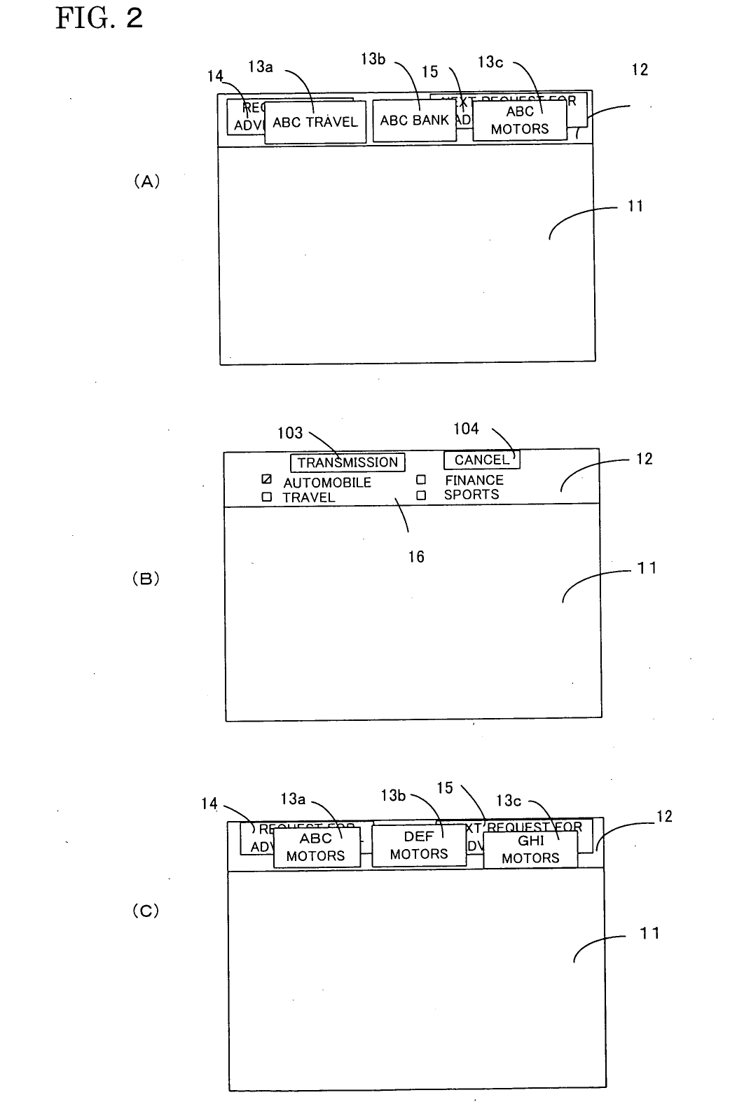

In FIG. 1, the user uses client terminals 4a, 4b, 4c, . . . , 4d to access each site on Internet 5. When the web page of advertisement posting servers 3a, 3b, 3c, . . . , 3d is accessed by client terminals 4a, 4b, 4c, . . . , 4d, advertising area 12 is displayed in the web page area 11 as shown in FIG. 2(A). To advertising area 12 of web page area 11, the link information to advertisement delivery server 1 is added, and advertising area 12 is displayed based on the information from advertisement delivery server 1. Or, broadcasting station 6 transmits the advertising area embedded in web pages of advertisement posting servers 3a, 3b, 3c, . . . , 3d to client terminals 4a, 4b, 4c, . . . , 4d by broadcasting.

In advertising area 12, banner images 13a, 13b, 13c and category selection button 14, and reload button 15 are included. In the first access, in banner images 13a, 13b, 13c, banner advertising of an optional company is displayed. In this example, banner images of companies of different three categories of advertisement; “ABC Travel” advertisement as banner image 13a, “ABC Bank” advertisement as banner image 13b, and “ABC Motors” advertisement as banner image 13c, are displayed. Now, in this event, the number of banner images is three, but the number of banner images should not be limited to this.

Clicking category selection button 14 in this event displays category selection screen 16 in advertising area 12 as shown in FIG. 2(B). In category selection screen 16, a list of categories of advertisements such as “automobile”, “finance”, “Travel”, “sports”, etc. and check boxes are displayed. In category selection screen 16, transmission button 103 and cancellation button 104 are provided.

The user of client terminal 4 views the list of categories and selects a category which she/he is interested in. Here, for example, from category selection screen 16, the category of “automobile” is selected, and a check box of automobile category is checked.

Clicking transmission button 103 after the category which the user is interested is selected in by category selection screen 16 updates banner images 13a, 13b, 13c in accordance with the category which the user selects. As described above, when the user selects, for example, “automobile” as a category, banner images 13a, 13b, 13c of companies whose category is related to “automobile” only are displayed, such as advertisement of “ABC Motors”, advertisement of “CDF Motors”, advertisement of “GHI Motors”,”, etc. as shown in FIG. 2(C).

In the above-mentioned example, the user selected one category in category selection screen 16, but a plurality of categories may be selected. When a plurality of categories are selected, banner advertisements related to a plurality of categories selected are displayed.

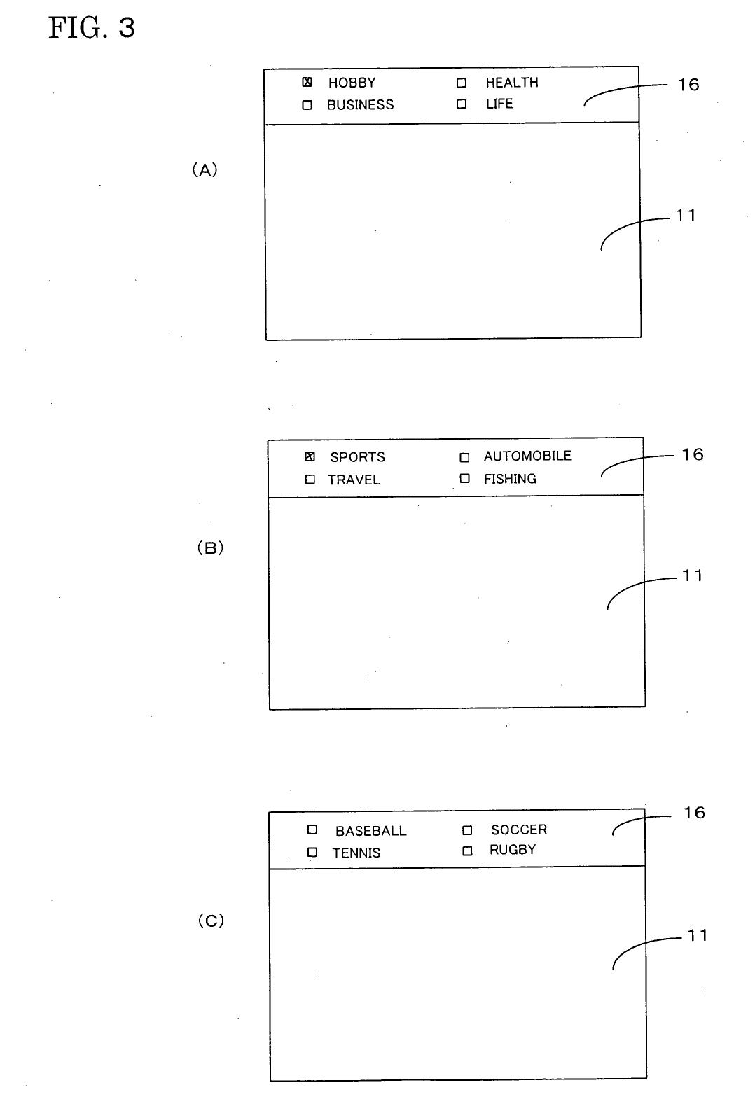

In the above-mentioned example, a list of categories is displayed on category selection screen 16, but this category selection screen 16 may be stratified into major classification, middle classification, and minor classification. For example, as shown in FIG. 3(A), categories of major classification such as “hobby”, “business”, “health”, “life” are displayed first on category selection screen 16, and when, for example, “hobby” is selected here, as shown in FIG. 3(B), categories of middle classification such as “sports”, “travel”, “automobile”, and “fishing” are displayed, and further selecting “sports” may display categories of minor classification such as “baseball”, “tennis”, “soccer”, and “rugby.”

In addition, in the example of FIG. 2, advertising area 12 is provided in web page area 11, but web page area 11 and advertising area 12 may be displayed in separate windows.

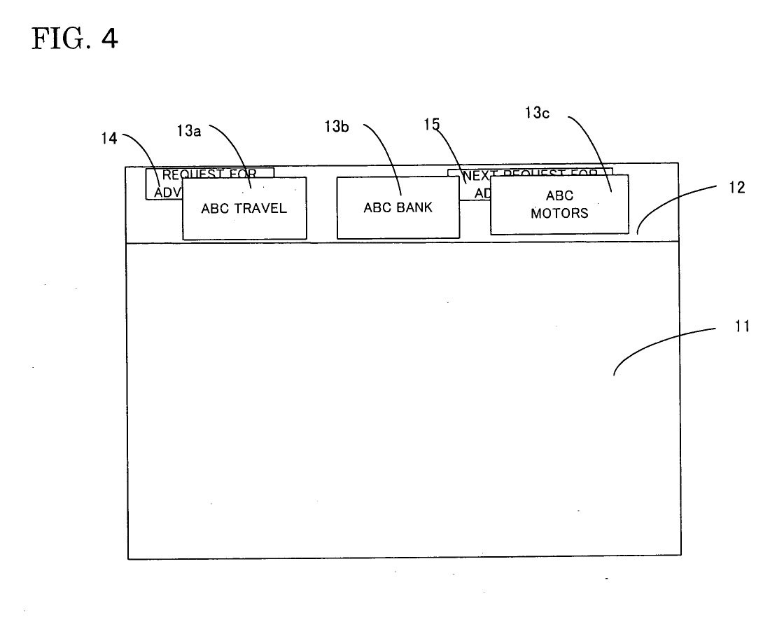

FIG. 4 is an example in which web page area 11 and advertising area 12 are divided above and below using frames. In FIG. 4, the upper-side frame is designated as advertising area 12 and the lower-side frame is designated as web page area 11. Needless to say, the upper-side frame may be designated as web page area 11 and the lower-side frame may be designated as advertising area 12. In addition, the frame may be divided right and left, and the left-side frame may be designated as web page area 11 and the right-side frame may be designated as advertising area 12, or the left-side frame may be designated as advertising area 12 and the right-side frame may be designated as web page area 11. In advertising area 12, banner image 13a, 13b, 13c is arranged. In addition, below this banner image 13a, 13b, 13c, category selection button 14 and reload button 15 are arranged.

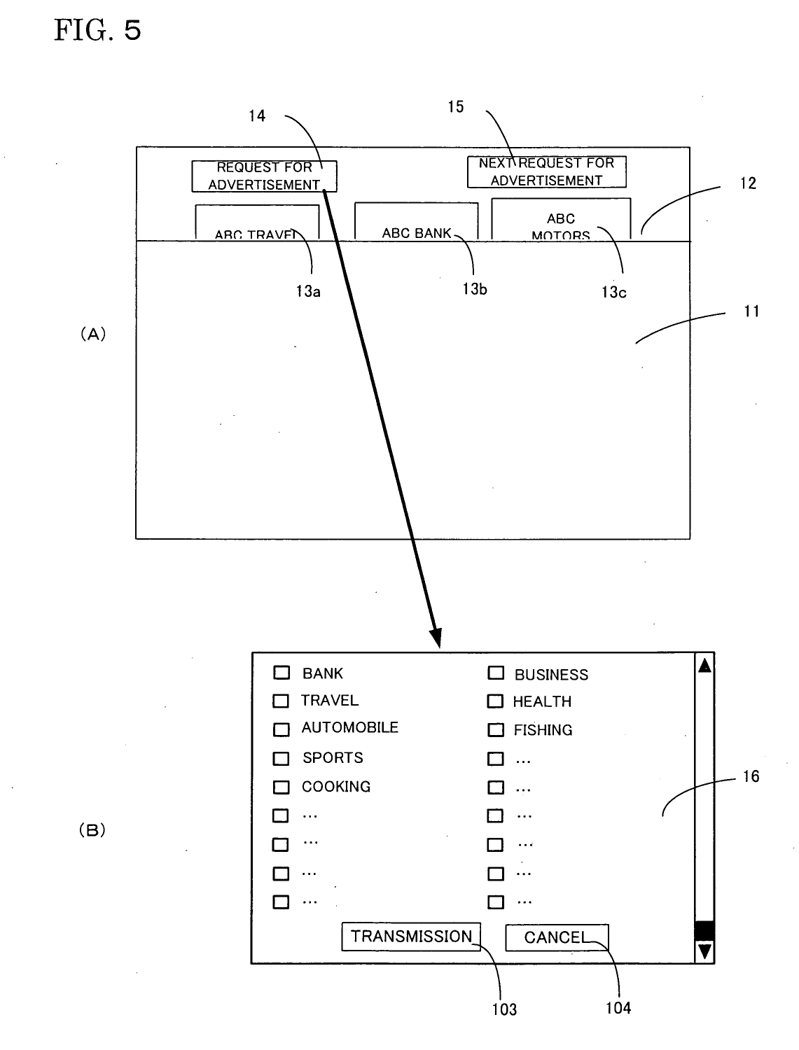

As shown in FIG. 5(A), banner image 13a, 13b, 13c can be moved in advertising area 12 by dragging operation, and when the position of banner image 13a, 13b, 13c is moved, reload button 15 and category selection button 14 can be used easily.

Clicking category selection button 14 displays category selection screen 16, for example, in a separate window as shown in FIG. 5(B). In category selection screen 16, categoriy names and checkboxes for selecting the category name are displayed. In addition, in category selection screen 16, transmission button 103 and cancellation button 104 are provided.

When the user of client terminal 4 selects categories of advertisement, the user clicks checkboxes of categories which the user is interested in to put a check and clicks transmission button 103. When transmission button 103 is clicked, category ID of advertisement selected by adding a checkmark is transmitted to advertisement delivery server 1. Clicking cancellation button 104 resets each checkbox and selection of advertisement category can be redone.

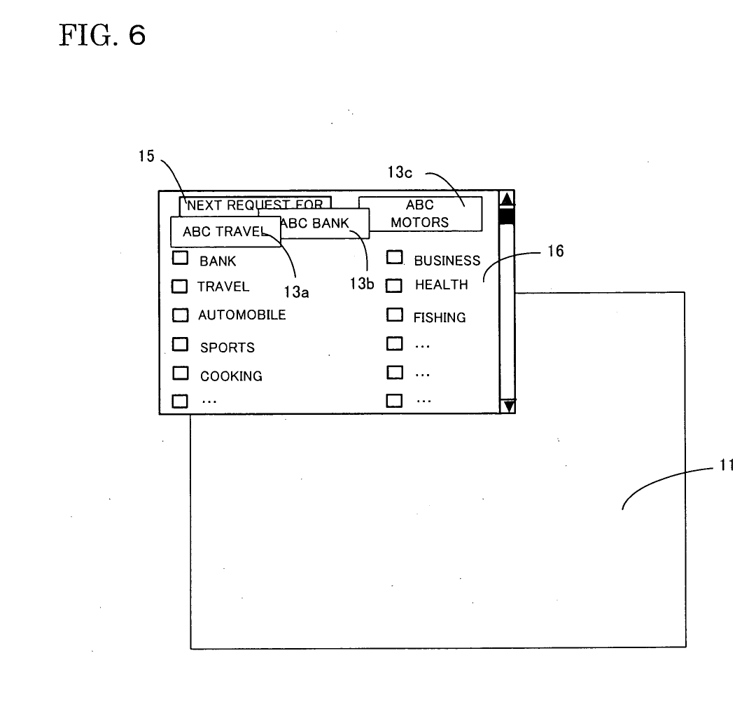

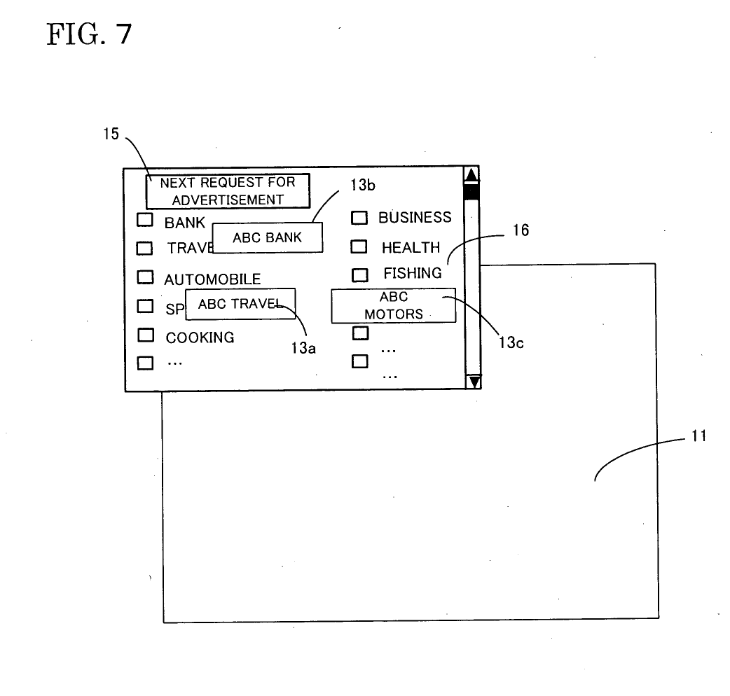

FIG. 6 and FIG. 7 are examples in which advertising area 12 and category selection screen 16 are combined and displayed using a separate window. In FIG. 6, over the window of web page area 11, a window with advertising area 12 and category selection screen 16 combined is arranged. By the way, in this example, on the upper layer of window of web page area 11, a window with advertising area 12 and category selection screen 16 combined is arranged, but needless to say, if the active window is used for the window of web page area 11, a window with advertising area 12 combined with category selection screen 16 is arranged below the window of web page area 11. On the window with advertising area 12 combined with category selection screen 16, banner image 13a, 13b, 13c is displayed overlapped. In addition, on the window with advertising area 12 combined with category selection screen 16, category name, checkboxes for selecting the category name, transmission button 103, and cancellation button 104 are arranged. When advertising area 12 is combined with category selection screen 16 in this way, category selection button 14 for calling category selection screen 16 is not required.

Banner image 13a, 13b, 13c can be moved by, for example, dragging operation, and when the position of banner image 13a, 13b, 13c is moved, reload button 15 is made easier to use.

By the way, in this example, category selection screen 16 is selected by using checkboxes, but any other method may be used. In addition, advertising categories are intended to be directly selected but other method may be used, for example, a method for defining the letter strings showing user characteristics and characteristics of the advertisement category in relationship with advertising categories in advance, and allowing a program to automatically select advertising categories based on the user characteristics entered.

Clicking banner image 13a, 13b, 13c is able to allow the user to jump to the adviser's web page that corresponds to the banner image 13a, 13b, 13c. In such event, the advertiser web page is displayed on web page area 11, and advertising area 12 containing banner image 13a, 13b, 13c may be kept displayed or on the whole window, the advertiser web page may be displayed and advertising area 12 may be deleted. In addition, the advertiser's web page may be displayed in a separate window, separate frame, or separate inline frame. In such event, banner image 13a, 13b, 13c is not always necessary to be displayed overlapped from the beginning. The number of banner images 13a, 13b, 13c may be freely set.

The overlapping condition and layout of banner image 13a, 13b, 13c, category selection button 14, reload button 15, or other screen display component elements can be changed in accord with designs. In addition, the position of reload button 15 and category selection button 14 may be able to be moved by user operation as required.

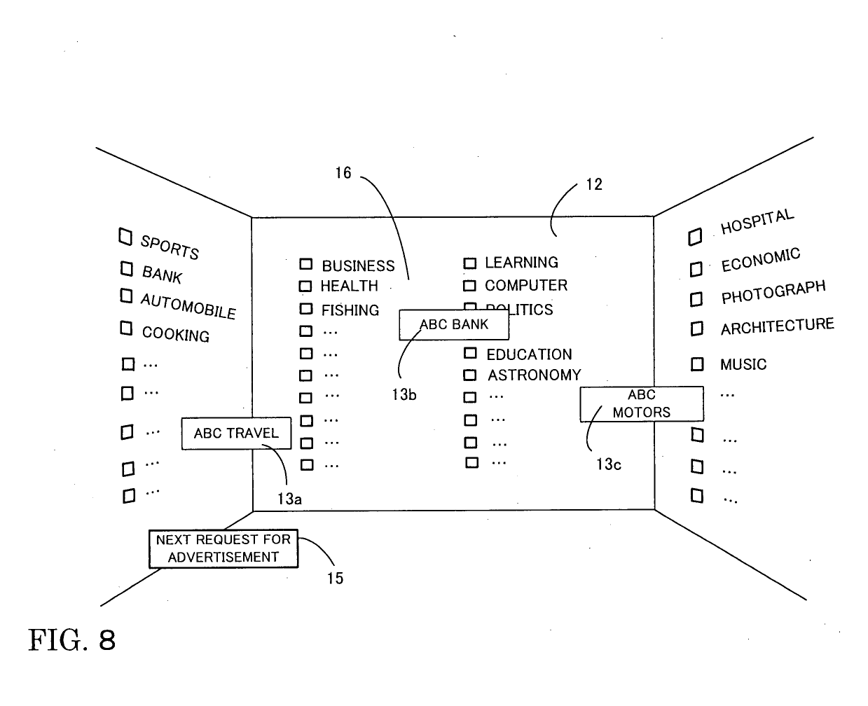

In addition, as shown in FIG. 8, the screen of advertising area 12 and category selection screen 16 may be displayed as virtual three-dimensional space. In such event, VRML (Virtual Reality Modeling Language) or applet by Java (trademark) languages are used for displaying the virtual three-dimensional space. In addition, for the screen of advertising area 12 and configuration of category selection screen 16, various other cases could be thought, and displaying techniques vary in accordance with the cases. For example, the whole advertising area 12 may be made in flash animations by Flash (trademark).

In this way, using advertisement delivery server 1 with the present invention applied enables the user to select categories of user's interest and can provide banner advertisements of categories of user's interest. The user views this banner advertisement and if there is any banner advertisement which the user is interested in, the user clicks the banner image of the banner advertisement. Clicking the banner image is able to take the user to the advertiser's web page whose URL is embedded in the banner image.

As described above, it is possible for the user to select the category which she/he is interested in, and to extract and provide the banner advertisement of the category only of the user's interest. This will bring profit to both sides, advertiser who posts the banner advertisement and the user who views the banner advertisement. That is, on the user side who views the banner advertisement, she/he can narrow down banner advertisements of the category of his/her interest only and can positively utilize the banner advertisement as information collecting sources. On the company side, the advertiser who posts the banner advertisement can catch customers who are interested in their products and can expect to increase the advertisement effects of the product.

### FIRST EMBODIMENT

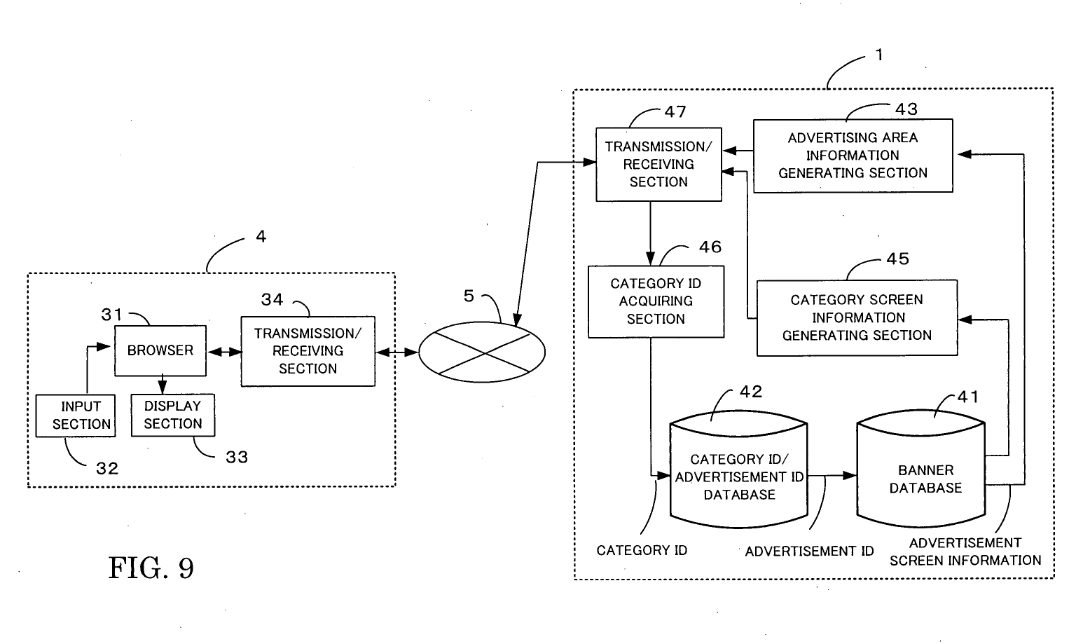

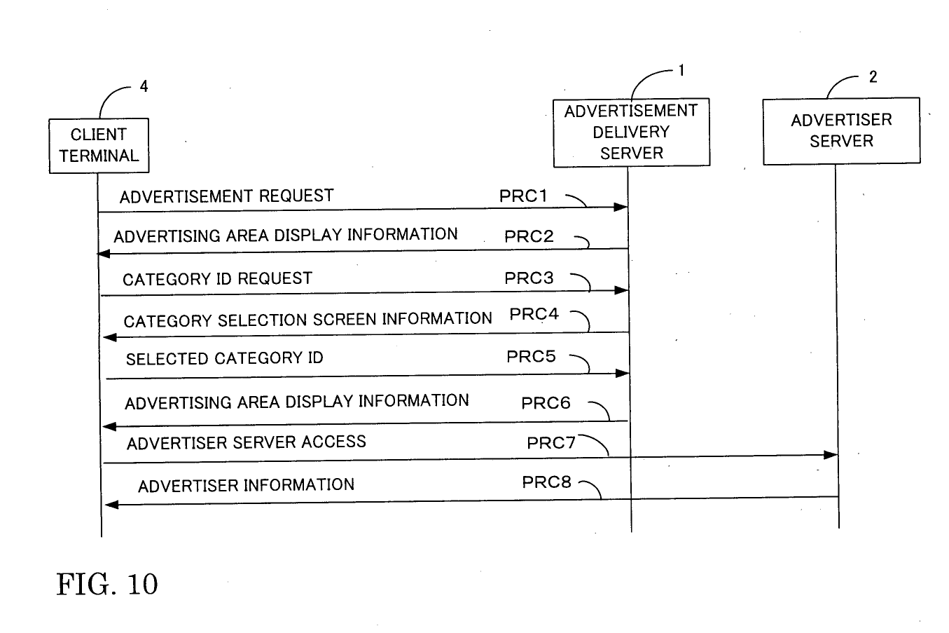

Next, description will be made on the system configuration in which as described above, accessing advertisement posting server 3a, 3b, 3c, . . . , 3d by client terminal 4 displays an advertising area on the web page, and the user can select categories of user's interest in this advertising area. FIG. 9 is a functional block diagram showing the configuration of the first embodiment of an advertisement delivery system with the present invention applied, and FIG. 10 is a sequence diagram showing its operation. As shown in FIG. 9, to user's client terminal 4, browser 31 is installed. Browser 31 enables the user to view the multimedia information by display section 33 by hyperlink of HTTP protocol. Browser 31 is operated by input section 32 comprising a keyboard, mouse, etc.

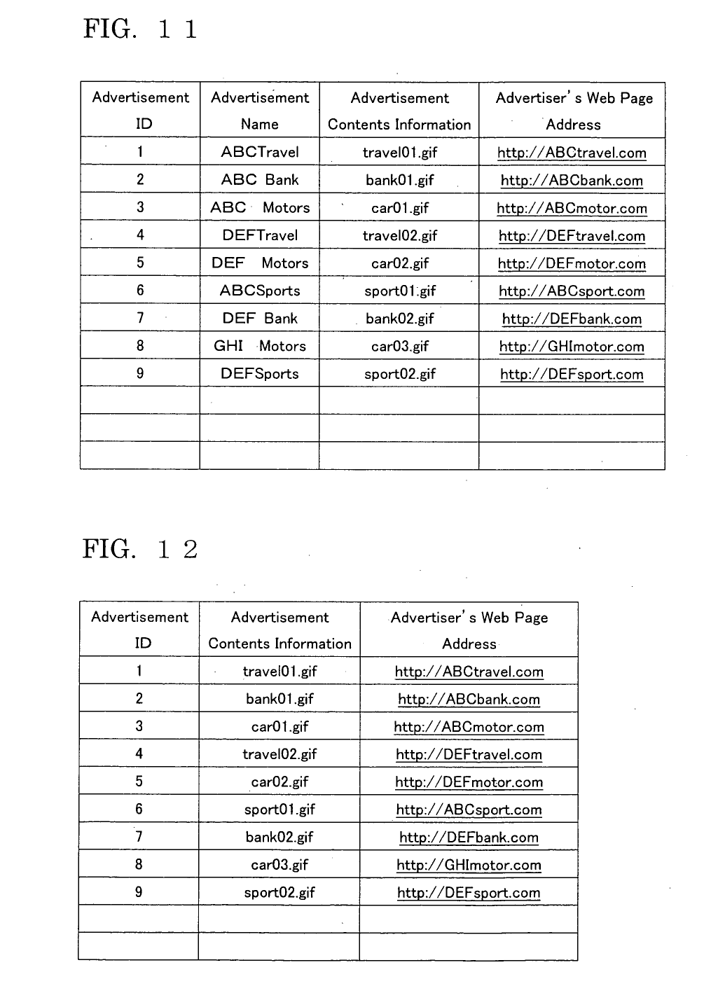

Advertisement delivery server 1 comprises banner database 41 and category ID/advertisement ID database 42 which corresponds to the delivered advertising screen information storage section. To banner database 41, as shown in FIG. 11, advertisement ID, advertisement name, advertising contents information, and address information of the advertiser's web page are described in connection with one another.

Advertisement ID is an ID that serves as an index for identifying each piece of advertising screen information. To the advertisement name, advertisement name of banner advertisement such as advertisement of “ABC Travel”, “advertisement of “ABC Bank”, advertisement of “ABC Motors”, etc. are stated. To the advertising contents information, banner image information (file name and location on the file) is stated. The banner image file itself may be located anywhere on Internet 5 but is generally located in advertisement delivery server 1 or advertiser server 2a, 2b, 2c, . . . , 2d. In addition, as described above, the advertising contents information may be applet information written by Java (trademark) language or flash animations by information of Flash (trademark). To the address to be linked, location of advertiser's web page, that is, advertiser's web page URL (Uniform Resource Locator) or URI (Uniform Resource Identifier) is stated.

In FIG. 11, in order to understand the contents of banner database 41 more easily, the advertisement name is stated in banner database 41. However, since the advertisement name can be identified by advertisement ID, the advertisement name may not be stated. FIG. 12 shows the configuration of banner database 41 when the advertisement name is not stated.

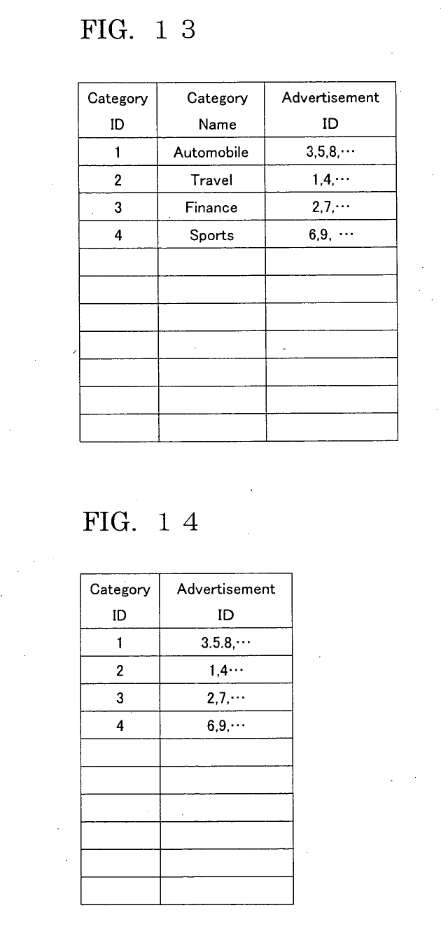

In category ID/advertisement ID database 42, as shown in FIG. 13, category ID and category name, and advertisement ID that belongs to the category are stated in connection to each other. Category ID is, for example, (category ID=1) is “automobile”, (category ID=2) is “travel”, (category ID=3) is “finance”, and (category ID=4) is “sports”.

Based on banner database 41 shown in FIG. 11, the advertisement that belongs to “automobile” category is the advertisement of “ABC Motors” of (advertisement ID=3), advertisement of “DEF Motors” of (advertisement ID=5) and advertisement of “GHI motors” of (advertisement ID=8). Consequently, as shown in FIG. 13, to “automobile” of (category ID=1), “3”, “5”, “8”, . . . are stated as advertisement IDs. The advertisement that belongs to category of “travel” is the advertisement of “ABC Travel” of (advertisement ID=1) and advertisement of “DEF Travel” of (advertisement ID=4). Consequently, to “travel” of (category ID=2), “1”, “4”, . . . are stated as advertisement IDs. The advertisement that belongs to category of “finance” is the advertisement of “ABC Bank” of (advertisement ID=2) and advertisement of “DEF Bank” of (advertisement ID=7). Consequently, to “finance” of (category ID=3), “2”, “7”, . . . are stated as advertisement IDs. The advertisement that belongs to category of “sports” is the advertisement of “ABC Sports” of (advertisement ID=6) and advertisement of “DEF Sports” of (advertisement ID=9). Consequently, to “sports” of (category ID=4), “6”, “9”, . . . are stated as advertisement IDs. Thereafter, in the same manner, to category ID/advertisement ID database 42, advertisement ID that belongs to each category is stated.

By the way, in FIG. 13, in order to understand the contents of category ID/advertisement ID database 42 more easily, the category name is stated in category ID/advertisement ID database 42 but since the category name can be identified by category ID, it may not be stated. FIG. 14 shows the configuration of category ID/advertisement ID database 42 when the category name is not stated.

In FIG. 9, advertisement delivery server 1 further comprises advertising area information generating section 43, category screen information generating section 45, and category ID acquiring section 46. Advertising area information generating section 43 generates the advertising area display information for displaying an image of advertising area 12 containing advertising screen information read from banner database 41. Category screen information generating section 45 generates the category selection screen information for displaying an image of category selection screen 16 based on the category of category ID/advertisement ID database 42. Category ID acquiring section 46 acquires the selection category ID sent from client terminal 4.

As shown in the sequence diagram of FIG. 10, when an advertisement request is sent from client terminal 4, advertisement delivery server 1 takes out, for example, three optional advertising screen information from banner database 41, and send the taken out advertising screen information to advertising area information generating section 43. Advertising area information generating section 43 generates the advertising area display information for displaying advertising area 12 containing advertising screen information taken out from banner database 41 and transmits this advertising area display information from transmission/receiving section 47 to client terminal 4 (process PRC2).

That is, when an advertisement request is sent from client terminal 4, for example, three advertising screen information are taken out from banner database 41 shown in FIG. 11. By the first access, any advertising screen information may be taken out, and in this case, let's assume that three advertising screen information of “1”, “2”, and “3” of advertisement IDs are taken out. The advertisement of (advertisement ID=1) is an advertisement of “ABC Travel”, the advertisement of (advertisement ID=2) is an advertisement of “ABC Bank”, and the advertisement of (advertisement ID=3) is an advertisement of “ABC Motors”. The advertising screen information of these advertisement IDs are sent to advertising area information generating section 43.

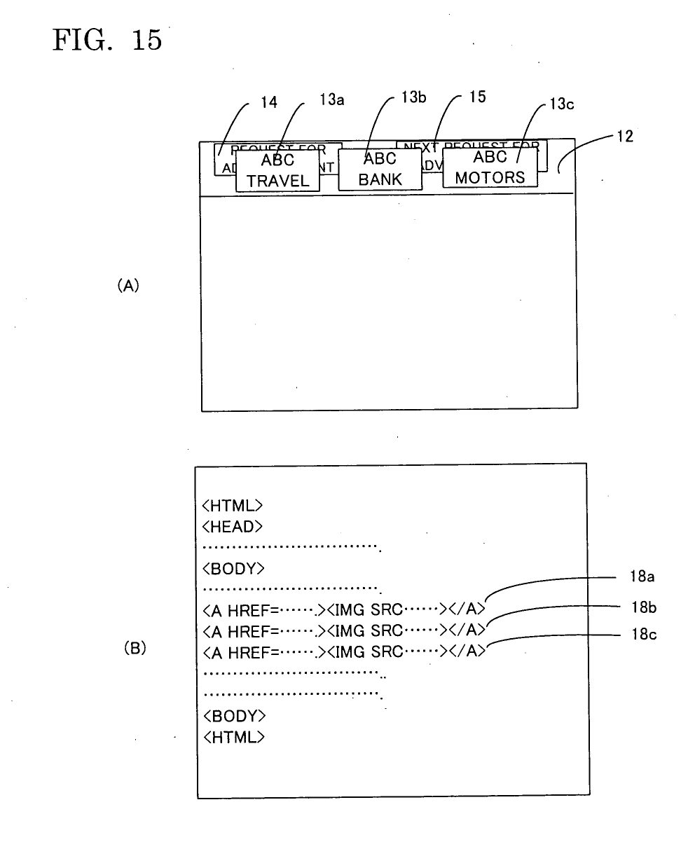

Advertising area information generating section 43 generates the advertising area display information to be displayed in advertising area 12 containing advertising screen information taken out from banner database 41. That is, in order to generate a screen displayed in advertising area 12 as shown in FIG. 15(A), the advertising area display information written in hyperlink language as shown in FIG. 15(B) is prepared. In addition, from banner database 41 to advertising area information generating section 43, advertisement contents information and address information of the advertiser's web page of three selected advertising screen information are sent. At advertising area information generating section 43, in the advertising area display information written in a hyperlink language such as FIG. 15(B), contents file name (travel01.gif) and the advertiser's web page to be linked (http://ABCtravel.com/) of (advertisement ID=1) read from banner database 41 are embedded in the descriptive portion 18a of banner image 13a. Contents file name (bank01.gif) and the advertiser's web page to be linked (http://ABCbank.com/) of (advertisement ID=2) are embedded in the descriptive portion 18b of banner image 13b. Contents file name (car01.gif) and the advertiser's web page to be linked (http://ABCmotor.com/) of (advertisement ID=3) are embedded in the descriptive portion 18c of banner image 13c. By this, the advertising area display information written by a hyperlink language is generated. The advertising area display information generated by this advertising area information generating section 43 is sent from transmission/receiving section 47 of advertisement delivery server 1 to user's client terminal 4 via Internet 5.

Browser 31 of client terminal 4 receives the advertising area display information written in the hyperlink language from advertisement delivery server 1 via Internet 5 by transmission/receiving section 34. This advertising area display information is sent from transmission/receiving section 34 to browser 31.

Browser 31 generates a screen of advertising area 12 by hyperlink by HTTP protocol when it receives the advertising area display information written in this hyperlink language. The screen of advertising area 12 formed in this way is displayed on display section 33.

As described above, because in the advertising area information sent from advertisement delivery server 1, contents file name (travel01.gif) and advertiser's web page to be linked (http://ABCtravel.com/) of (advertisement ID=1) are embedded in descriptive portion 18a of banner image 13a, contents file name (bank01.gif) and advertiser's web page to be linked (http://ABCbank.com/) of (advertisement ID=2) are embedded in descriptive portion 18b of banner image 13b, and contents file name (car01.gif) and advertiser's web page to be linked (http://ABCmotor.com/) of (advertisement ID=3) are embedded in descriptive portion 18c of banner image 13c, in banner image 13a, the advertisement of “ABC Travel” is displayed, in banner image 13b, an advertisement of “ABC Bank” is displayed, and in banner image 13c, an advertisement of “ABC Motors” is displayed (see FIG. 2(A)).

In this way, at the beginning of access, in advertising area 12, banner images 13a, 13b, 13c of advertisement of optional categories are displayed. When the user of client terminal 4 wants to display a banner advertisement of a category of his/her interest, category selection button 14 in the screen of advertising area 12 is clicked.

When category selection button 14 in the screen of advertising area 12 is clicked in client terminal 4, a category ID request is transmitted from client terminal 4 to advertisement delivery server 1 (process PRC3).

Advertisement delivery server 1 prepares category selection screen information based on the data stored in category ID/advertisement ID database 42 at category screen information generating section 45 and transmits to client terminal 4 when advertisement delivery server 1 receives category ID request (process PRC4).

That is, at category screen information generating section 45, descriptive information of category selection screen 16 described in the hyperlink language is prepared. In addition, from category ID/advertisement ID database 42 shown in FIG. 13, category information is sent. At category screen information generating section 45, the category information obtained from category ID/advertisement ID database 42 is embedded in the descriptive information of hyperlink language of category screen. The category selection screen information prepared in this way is transmitted to client terminal 4 via transmission/receiving section 47.

When the category selection screen information from advertisement delivery server 1 is received at client terminal 4, in advertising area 12 of display section 33, category selection screen 16 is displayed based on this category selection screen information (see FIG. 2(B)). The user views this category selection screen 16 and selects a category of his/her interest.

When the category is selected on category selection screen 16 and transmission button 103 is clicked, a selected category ID is sent from client terminal 4 to advertisement delivery server 1 (process PRC5).

When transmission/receiving section 47 of advertisement delivery server 1 receives the selected category ID from this client terminal 4, transmission/receiving section 47 sends this category ID to category ID acquiring section 46. Category ID acquiring section 46 identifies the category ID of the selected category and sends this category ID to category ID/advertisement ID database 42. Category ID/advertisement ID database 42 outputs advertisement IDs of the corresponding category when it receives the category IDs.

For example, assume that a category of “automobile” is selected. In such event, (category ID=1) that corresponds to the “automobile” category is acquired by category ID acquiring section 46. When (category ID=1) is entered in category ID/advertisement ID database 42 shown in FIG. 13, “3”, “5”, “8”, . . . are outputted as advertisement IDs that belong to the category from category ID/advertisement ID database 42. These advertisement IDs are sent to banner database 42.

When advertisement IDs of “3”, “5”, “8”, . . . are sent to banner database 41, advertising screen information of (advertisement ID=3), (advertisement ID=5), (advertisement ID=8), . . . are taken out from banner database 41. (Advertisement ID=3) is the advertisement of “ABC Motors”, (advertisement ID=5) is the advertisement of “DEF Motors”, and (advertisement ID=8) is the advertisement of “GHI Motors”, which are all advertising screen information that belong to “automobile”. Consequently, in this case, advertising screen information that all belong to “automobile” category are taken out. From these pieces of advertising screen information, for example, three pieces of advertising screen information are extracted. By the way, in this case, any advertising screen information may be extracted from the advertising screen information that belongs to the “automobile” category, and in this example, three pieces of advertising screen information of (advertisement ID=3), (advertisement ID=5), and (advertisement ID=8) are extracted in order of advertisement IDs. The order of extracting advertising screen information should not be restricted to this. For example, the order of advertising screen information extracted may be changed by advertisement fees.

The advertising screen information that belongs to “automobile” extracted in this way is sent to advertising area information generating section 43. Advertising area information generating section 43 generates information for displaying advertising area 12 containing advertising screen information taken out from banner database 41.

That is, as shown in FIG. 15(B), in the descriptive information of hyperlink language for generating a screen of advertising area 12, contents file name (car01.gif) and the advertiser's web page to be linked (http://ABCmotor.com/) of (advertisement ID=3) are embedded in the descriptive portion 18a of banner image 13a, contents file name (car02.gif) and the advertiser's web page to be linked (http://DEFmotor.com/) of (advertisement ID=5) are embedded in the descriptive portion 18b of banner image 13b, and contents file name (car03.gif) and the advertiser's web page to be linked (http://GHImotor.com/) of (advertisement ID=8) are embedded in the descriptive portion 18c of banner image 13c, and the advertising area display information written by a hyperlink language is generated. The advertising area display information generated by this advertising area information generating section 43 is sent from transmission/receiving section 47 of advertisement delivery server 1 to user's client terminal 4 via Internet 5 (Process PRC6).

Browser 31 of client terminal 4 generates a screen of advertising area 12 by hyperlink by HTTP protocol when it receives the advertising area display information written in this hyperlink language and allows it to be displayed on display section 33. Because in the advertising area display information, contents file name (car01.gif) and advertiser's web page to be linked (http://ABCmotor.com/) of (advertisement ID=3) are embedded in a descriptive portion of banner image 13a, contents file name (car02.gif) and advertiser's web page to be linked (http://DEFmotor.com/) of (advertisement ID=5) are embedded in a descriptive portion of banner image 13b, and contents file name (car03.gif) and advertiser's web page to be linked (http://GHImotor.com/) of (advertisement ID=8) are embedded in a descriptive portion of banner image 13c, in banner image 13a, the advertisement of “ABC Motors” is displayed, in banner image 13b, an advertisement of “DEF Motors” is displayed, and in banner image 13c, an advertisement of “GHI Motors” is displayed. In this way, at the portions of banner image 13a, 13b, 13c, images of banner advertising that belongs to “automobile” category only are projected based on the advertising screen information of (advertisement ID=3), (advertisement ID=5), and (advertisement ID=8) (see FIG. 2(C)).

Clicking the portion of banner image 13a, 13b, 13c is able to take the user to the advertiser server 2a, 2b, 2c, . . . , 2d of companies that belong to the category of “automobile” embedded in the portion of the banner image 13a, 13b, 13c (process PRC7). And the information of web page of the advertiser server 2a, 2b, 2c, . . . , 2d to be linked is sent to client terminal 4 and displayed on a display of client terminal 4 (process PRC8).

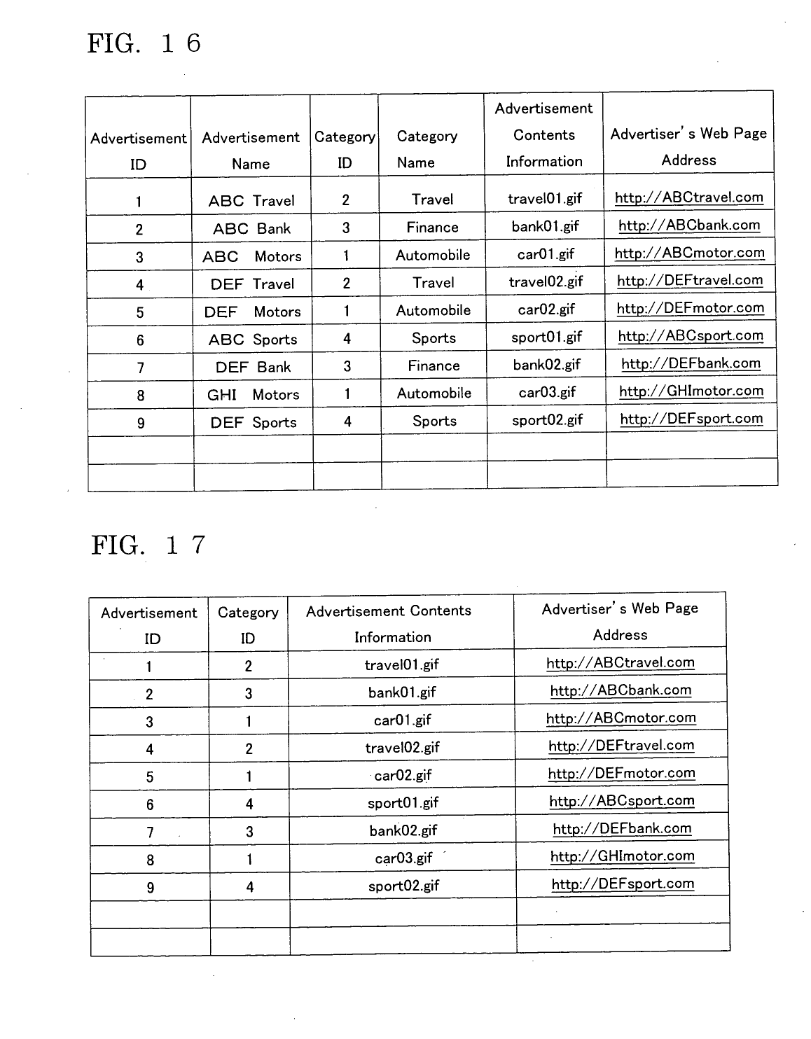

By the way, in the above-mentioned example, in order to extract the advertising screen information that corresponds to the category selected at user's client terminal 4, category ID/advertisement ID database 42 and banner database 41 were used, but as shown in FIG. 16, category ID/advertisement ID database 42 and banner database 41 may be combined into one to form a banner database with category. As shown in FIG. 16, in the banner database with category, advertisement ID, advertisement name, category ID, category name, advertising contents information, and advertiser's web page address are described in connection with one another. In this kind of banner database with category, advertisement ID of a desired category can be extracted in the category ID field.

By the way, in FIG. 16, in order to facilitate understanding of the contents of banner database with category, advertisement name and category name are stated in banner database with category, but since the advertisement name can be identified by advertisement ID and category can be identified by category ID, advertisement name and category name may not be stated. FIG. 17 shows the configuration when advertisement name and category name are not stated.

### SECOND EMBODIMENT

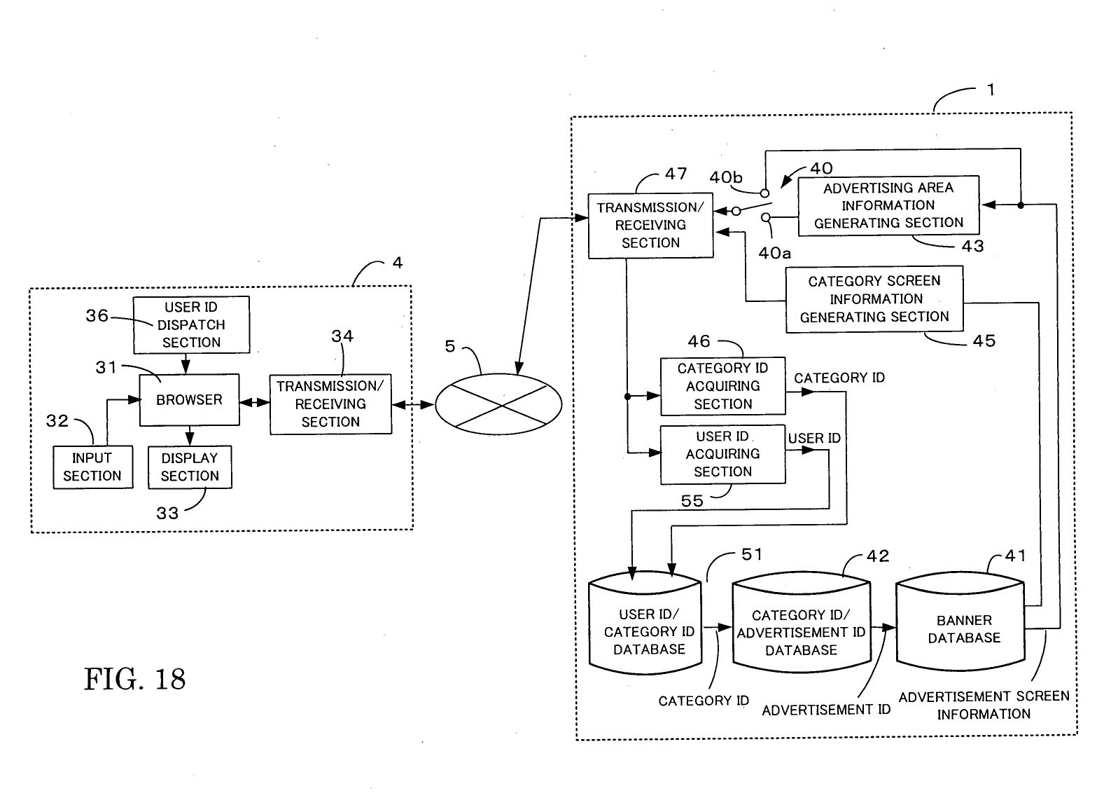

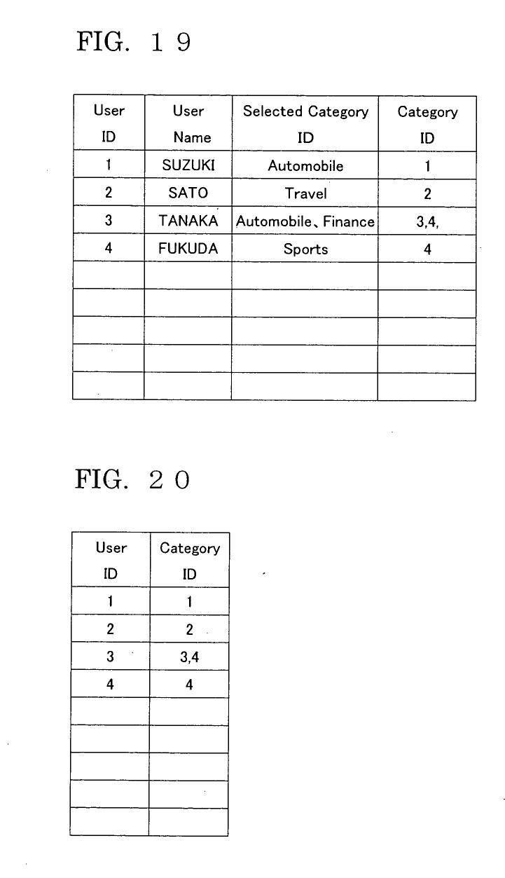

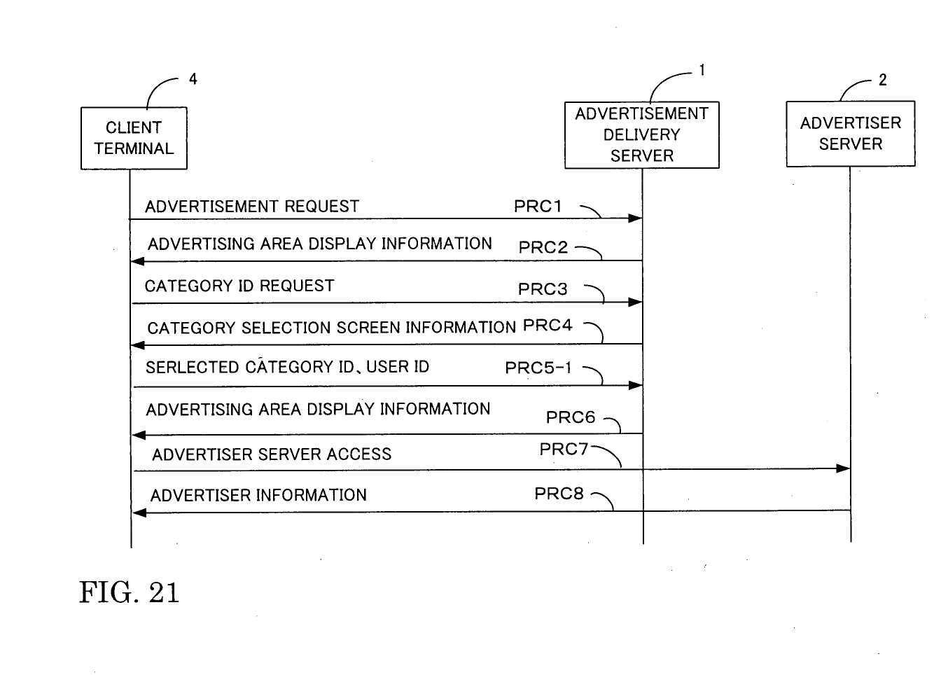

FIG. 18 is a functional block diagram showing the configuration of the second embodiment of the present invention, and FIG. 21 is a sequence diagram showing the operation. In the following embodiments, the same reference numerals are given to the portions same as those in the first embodiment. In this embodiment, in order to store the category ID which the user selected, user ID/category ID database 51 that corresponds to the category information storage section is provided. In user ID/category ID database 51, user ID, user name, selected category name, and category ID are stated in connection with one another as shown in FIG. 19.

User ID is an ID that serves as an index for identifying the user, and user name is the name of the user. In actuality, the user name is not always the real name but account name, IP address, etc. may be stated. Any user name may be acceptable as long as it can identify the user. For the selected category name, “automobile”, “travel”, “finance”, and other category names which the user selected are stated. In the category ID, a category ID that corresponds to the selected category is stated.

In FIG. 19, in order to facilitate understanding of the contents of user ID/category ID database 51, user name and selected category name are stated in user ID/category ID database 51, but since the user name can be identified by user ID and selected category name can be identified by selected category ID, user name and selected category name may not be stated and user ID/category ID database 51 may be configured as shown in FIG. 20.

In FIG. 18, user ID dispatch section 36 is provided at client terminal 4. From user ID dispatch section 36, a user ID is dispatched. The user ID is information for identifying the user and examples include a sequential number by numerical values, account name, IP address, etc.

Because in the second embodiment, category ID selected by the user is stored on advertisement delivery server 1 side, clicking transmission button 103 after the user selects the category once enables banner advertisements of the category to be updated one after another only by clicking reload button 15 thereafter.

Because in this embodiment, operations until advertising area 12 containing optional three banner images 13a, 13b, 13c is displayed on client terminal 4 after accessing advertisement posting server 3 from client terminal 4 are same as those of the first embodiment described above, the explanation will be omitted. This part of the section will describe operations after category selection screen 16 is displayed in client terminal 4 based on the category selection screen information from advertisement delivery server 1.

When category selection screen information from advertisement delivery server is received at client terminal 4, at display section 33, category selection screen 16 is displayed on the basis of this category selection screen information, and the user views this category selection screen 16 and selects categories which the user is interested in. In the category selection screen, the categories are selected and transmission button 103 is clicked, the selected category ID is sent from client terminal 4 to advertisement delivery server 1. In addition, in this event, user ID from user ID dispatch section 36 is simultaneously dispatched from client terminal 4 to advertisement delivery server 1 (process PRC5-1).

Advertisement delivery server 1 receives the selected category ID and user ID from client terminal 4. The category ID is acquired at category ID acquiring section 46 and the user ID is acquired at user ID acquiring section 55. The acquired category ID and user ID are sent to user ID/category ID database 51. Based on this category ID and user ID, user ID/category ID database 51 as shown in FIG. 19 is prepared.

For example, when at client terminal 4 with user name “SUZUKI” assigned, “automobile” is selected as category ID, “1” is acquired as user ID at user ID acquiring section 55 and “1” is acquired at category ID acquiring section 55 as category ID. Based on this, as shown in FIG. 19, “automobile” is stated as a selected category name whose user name is “SUZUKI” and [1] is stated as the category ID. In this way, in user ID/category ID database 51, selected category information for each user is stored. And this category ID is sent to category ID/advertisement ID database 42.

In category ID/advertisement ID database 42, as shown in FIG. 13, advertisement ID for each category is stated. When (category ID=1) is sent to category ID/advertisement ID database 42, from category ID/advertisement ID database 42, advertisement ID concerning “automobile” of (category ID=1) is outputted. As shown in FIG. 13, the advertisement IDs concerning “automobile” of (category ID=1) is “3”, “5”, “8”, . . . . Consequently, from category ID/advertisement ID database 42, “3”, “5”, “8”, . . . advertisement IDs are outputted.

The “3”, “5”, “8”, . . . advertisement IDs whose category belongs to “automobile” are sent to banner database 41. From banner database 41, advertising screen information of three advertisement IDs, for example, “3”, “5”, and “8”, are extracted and outputted from the advertising screen information of advertisement IDs of “3”, “5”, “8” whose category belongs to “automobile.” The advertising screen information of the three extracted advertisement IDs are sent to advertising area information generating section 43. The extracted three advertising screen information is sent to advertising area information generating section 43.

In advertising area information generating section 43, advertising area display information for displaying advertising area 12 is generated based on the advertising screen information sent from banner database 41. The advertising area display information generated at this advertising area information generating section 43 is sent from transmission/receiving section 47 of advertisement delivery server 1 to client terminal 4 via Internet (process PRC6).

When browser 31 of client terminal 4 receives the advertising area display information described in the hyperlink language, a screen of advertising area 12 is generated by hyperlink by HTTP protocol from this hyperlink language, and the screen of this advertising area 12 is displayed on display section 33. In the sections of banner image 13a, 13b, 13c of advertising area 12, images of banner advertisement that belongs to “automobile” category only are projected.

Now, when reload button 15 is clicked to update the advertisement banner, user ID is transmitted from user ID dispatch section 36 of client terminal 4 to advertisement delivery server 1. This user ID is acquired at user ID acquiring section 55 and sent to user ID/category ID database 51.

When user ID is sent to user ID/category ID database 51, the category ID selected by the user is searched at user ID/category ID database 51. For example, when user ID acquired at user ID acquiring section 55 is “1”, (category ID=1) is searched as category ID of (user ID=1) from user ID/category ID database 51 shown in FIG. 19. In such event, in response to the request from client terminal 4 of (user ID=1), category ID of “1” is read and this category ID is sent to category ID/advertisement ID database 42.

When category ID of (category ID=1) is sent from user ID/category ID database 51 to category ID/advertisement ID database 42, advertisement IDs of advertisement concerning “automobile” of (category ID=1), that is, “3”, “5”, “8”, . . . advertisement IDs are outputted from category ID/advertisement ID database 42. The advertisement IDs of “3”, “5”, “8”, . . . whose category belongs to “automobile” is sent to banner database 41. From banner database 41, advertising screen information of three advertisement IDs other than, for example, “3”, “5”, “8” extracted before, are extracted and outputted from the advertising screen information of advertisement IDs whose category belongs to “automobile.” The the advertising screen information of these advertisement IDs are sent to advertising area information generating section 43.

At advertising area information generating section 43, advertising area display information for displaying advertising area 12 is generated based on the advertising screen information sent from banner database 41. The advertising area display information generated at this advertising area information generating section 43 is sent from transmission/receiving section 47 of advertisement delivery server 1 to user's client terminal 4 via Internet 5 (process PRC6).

Browser 31 of client terminal 4 generates a screen of advertising area 12 by hyperlink by HTTP protocol from this hyperlink language and allows it to be displayed at display section 33 when it receives the advertising area display information described in hyperlink language. By this, at the portion of banner images 13a, 13b, 13c, images of new banner advertisements which belong to “automobile” category are projected.

By the way, when advertisements are updated to new advertisements, the whole advertising area 12 may be updated or the portion of banner images 13a, 13b, 13c only may be updated. Switch 40 is set in accordance with the case in which whole advertising area 12 is updated and the case in which banner images 13a, 13b, 13c only are updated. When switch 40 is set on the contact 40a side, all the advertising area is updated. When switch 40 is set on the contact 40b side, the portion of banner images 13a, 13b, 13c only is updated.

### THIRD EMBODIMENT

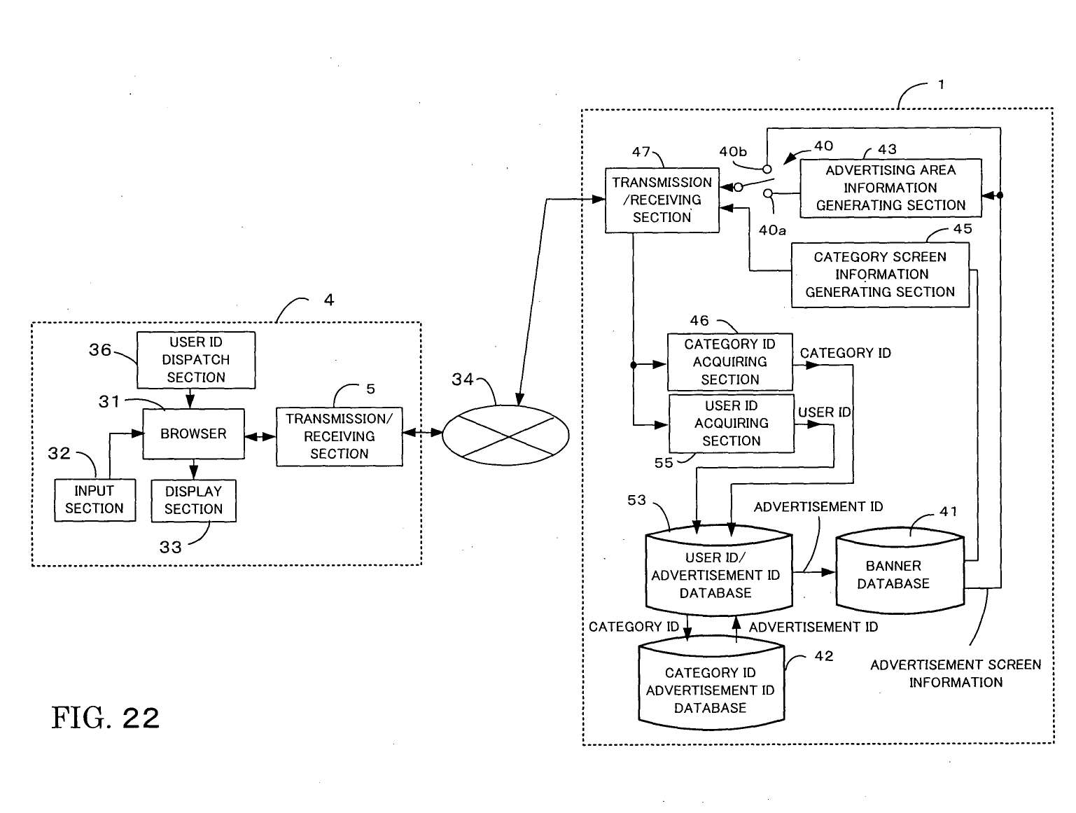

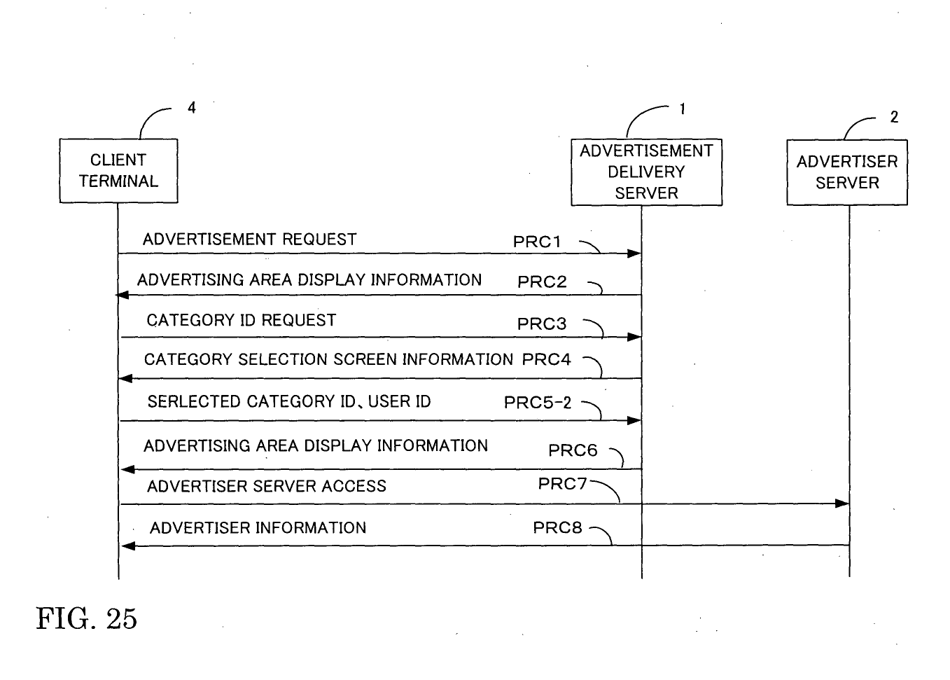

FIG. 22 is a functional block diagram showing the configuration of the third embodiment of the present invention, and FIG. 25 is a sequence diagram showing the operations. In the second embodiment described above, in order to store the category ID which the user selected, user ID/category ID database 51 is provided.

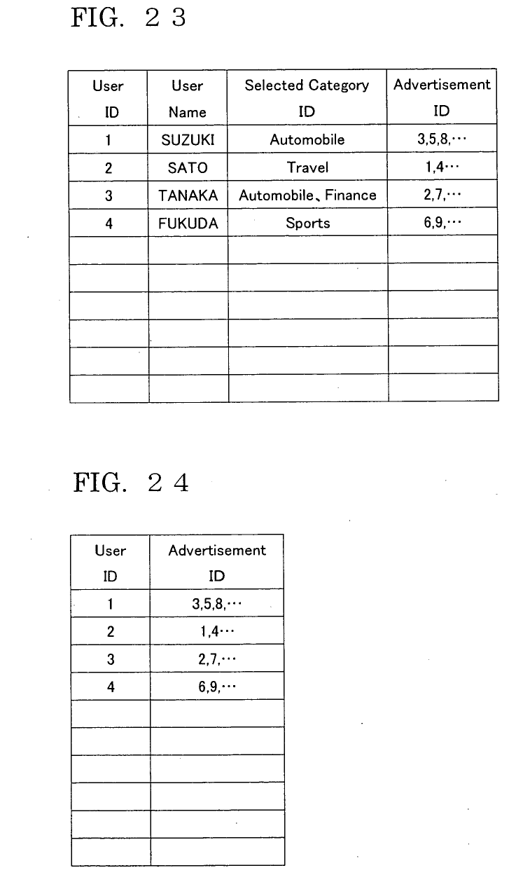

As against this, in this third embodiment, user ID/advertisement ID database 53 that corresponds to the advertising screen information storage section is provided. In this user ID/advertisement ID database 53, user ID, user name, selected category name, and advertisement IDs are described as shown in FIG. 23. In FIG. 23, for easy understanding of the contents of user ID/advertisement ID database 53, user name and selected category name are stated in user ID/advertisement ID database 53, but these is no need to state these. FIG. 24 shows a configuration of user ID/advertisement ID database 53 when user name and selected category name are not stated.

Because in this third embodiment, operations until advertising area 12 containing optional three banner images 13a, 13b, 13c is displayed on client terminal 4 after accessing advertisement posting server 3 from client terminal 4 are same as those of the first embodiment described above, the explanation will be omitted. This part of the section will describe operations after category selection screen 16 is displayed in client terminal 4 based on the selection screen from advertisement delivery server 1.

When category in category selection screen 16 is selected at client terminal 4 and transmission button 103 is clicked, the category ID is sent from client terminal 4 to advertisement delivery server 1 in FIG. 25, and user ID is transmitted from user ID dispatch section 36 (process PRC5-2).

Advertisement delivery server 1 receives the selected category IDs and user IDs from client terminal 4. The category IDs are acquired at category ID acquiring section 46 and the user IDs are acquired at user ID acquiring section 55. Based on this category IDs and user IDs, the user ID/advertisement ID database 53 as shown in FIG. 23 is prepared in reference to category ID/advertisement ID database 42.

For example, when the category IDs sent from client terminal 4 of (user ID=1) is “1”, advertisement IDs of “automobile” of (category ID=1) is searched in reference to category ID/advertisement D database 42. That is, from user ID/advertisement ID database 53 to category ID/advertisement ID database 42, (category ID=1) is sent. At category ID/advertisement ID database 42, user ID that corresponds to (category ID=1) is searched. As shown in FIG. 13, the advertisement ID concerning “automobile” of (category ID=1) is “3”, “5”, “8”, . . . . Consequently, from category ID/advertisement ID database 42, “3”, “5”, “8”, . . . advertisement ID are returned, and to user ID/advertisement ID database 53, “3”, “5”, “8”, . . . are stated as advertisement IDs for the user whose user ID is “1.” Similarly, advertisement IDs are stated for each user.

In response to the request from client terminal 4 whose user name is “SUZUKI”, from user ID/advertisement ID database 53, advertisement IDs of “3”, “5”, “8”, . . . , whose category belongs to “automobile” is outputted. This advertisement IDs of “3”, “5”, “8”, . . . is sent to banner database 41.

From banner database 41, advertising screen information of three advertisement IDs, for example, “3”, “5”, and “8”, are extracted and outputted. The three advertising screen information whose category belongs to “automobile” is sent to advertising area information generating section 43.

In advertising area information generating section 43, advertising area display information for displaying advertising area 12 is generated based on the advertising screen information sent from banner database 41. The advertising area display information generated at this advertising area information generating section 43 is sent from transmission/receiving section 47 of advertisement delivery server 1 to client terminal 4 via Internet (process PRC6).

Browser 31 of client terminal 4 generates a screen of an advertising area by hyperlink by HTTP protocol when advertising area display information described in the hyperlink language is received and allows it to be displayed at display section 33. By this, at display section 33, banner advertising images which belong to “automobile” category only are projected.

Now, when reload button 15 is clicked to update the advertisement banner, user ID is transmitted from user ID dispatch section 36 of client terminal 4 to advertisement delivery server 1. This user ID is acquired at user ID acquiring section 55 and this user ID is sent to user ID/advertisement ID database 53.

When user ID is sent to user ID/advertisement ID database 53, advertisement IDs of “3”, “5”, “8”, . . . advertisement IDs whose category belongs to “automobile” are outputted from user ID/advertisement ID database 53. These advertisement IDs whose category belongs to “automobile” are sent to banner database 41. From banner database 41, advertising screen information of three advertisement IDs other than, for example, “3”, “5”, “8” extracted before, are extracted and outputted of the advertising screen information which belongs to the category of “automobile.”

The advertising screen information of this “automobile” category is sent to advertising area information generating section 43. Advertising area information generating section 43 generate information for displaying advertising area 12 based on the contents image information and link information sent from banner database 41. The advertising area display information generated at this advertising area information generating section 43 is sent from transmission/receiving section 47 of advertisement delivery server 1 to user's client terminal 4 via Internet 5 (process PRC6).

Browser 31 of client terminal 4 generates a screen of advertising area by hyperlink by HTTP protocol and allows it to be displayed at display section 33 when it receives the advertising area display information described in hyperlink language. By this, at the portion of banner images 13a, 13b, 13c, images of new banner advertisements which belong to “automobile” category are projected.

### FOURTH EMBODIMENT

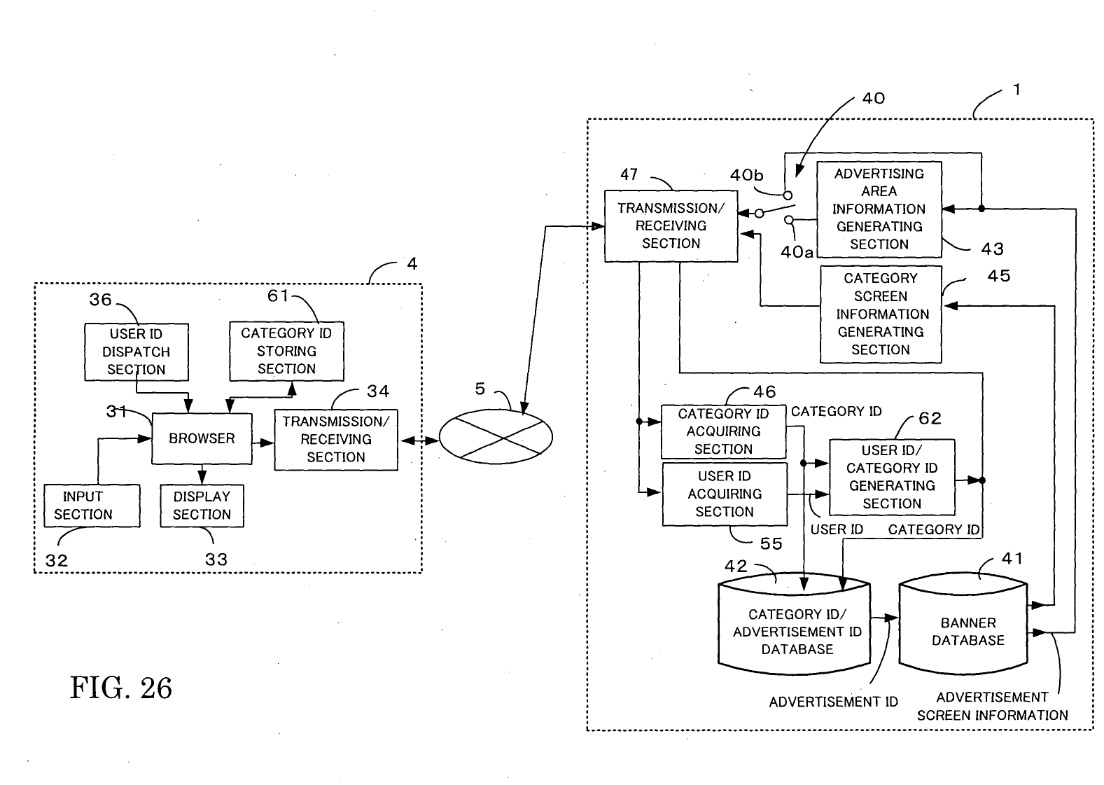

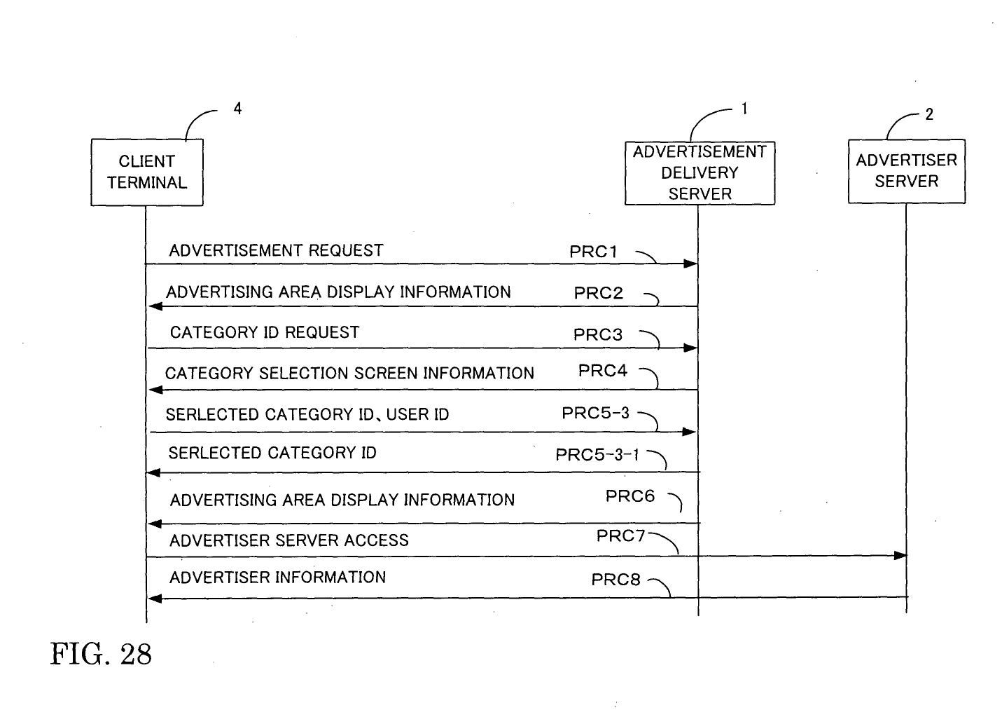

FIG. 26 is a functional block diagram showing the configuration of the fourth embodiment of the present invention, and FIG. 28 is a sequence diagram showing the operation. In the second and third embodiments described before, the selected categories or the advertisement IDs belong to the selected categoris are stored in advertisement delivery server 1, whereas in this fourth embodiment, the selected category is stored at client terminal 4. In this embodiment, for client terminal 4, category ID storing section 61 is provided. In this category ID storing section 61, category IDs of the categories which the user selects are stored.

By the way, to store category IDs selected on the client terminal 4 side, it is assumed to use, for example, Cookie. Cookie stores category IDs by the server provider who temporarily writes the data in the visitor's computer through browser. However, storage of the category IDs selected on the client terminal 4 side should not be restricted to Cookie.

In addition, on the advertisement delivery server 1 side, user ID/category ID generating section 62 is provided to generate information that indicates the correspondence of user ID for each user to category ID from the user ID and the category ID which the user selects.

When the category selection screen information from advertisement delivery server 1 is received at client terminal 4, category selection screen 16 is displayed on display section 33 based on this category selection screen information. When categories are selected on the category selection screen and transmission button 103 is clicked, selected category Ids are sent from client terminal 4 to advertisement delivery sever 1. In addition, in such event, user ID from user ID dispatch section 36 is transmitted from client terminal 4 to advertisement delivery server 1, too (Process PRC 5-3).

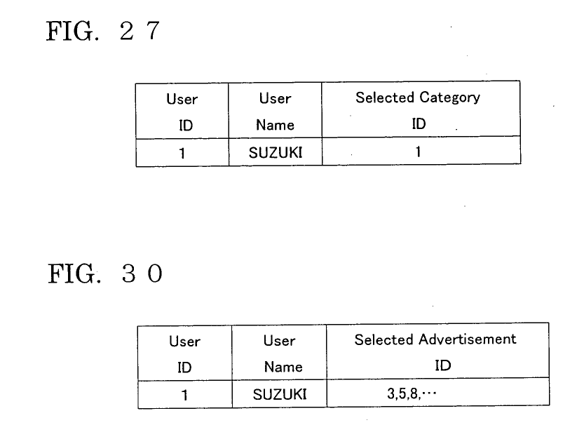

The advertisement delivery server 1 receives selected category ID and user ID fro client terminal 4. Category ID is acquired at category ID acquiring section 46, and user ID is acquired at user ID acquiring section 55. The acquired category ID and user ID are sent to user ID/category ID generating section 62. As shown in FIG. 27, based on the received category ID and user ID, the information that shows the correspondence relation between the user and category ID which the user selects.

For example, if user ID acquired at user ID acquired section 55 is “1” and category ID acquired at category ID acquired at category ID acquiring section 46 is “1”, as shown in FIG. 27, for (user ID=1) (user name is SUZUKI), information whose category ID is “1” (category name is “automobile”) is prepared. This information is returned to client terminal 4 (process PRC 5-3-1) and stored in category ID storing section 61 of client terminal 4. On the other hand, the selected category ID is sent to category ID/advertisement ID database 42.

In category ID/advertisement ID database 42, as shown in FIG. 13, advertisement ID for each category is listed. When category ID is sent to category ID/advertisement ID database 42, from category ID/advertisement ID database 42, advertisement IDs which belong to the selected category are outputted. Since in this case, (category ID=1) is selected, from category ID/advertisement ID database 42, advertisement IDs of “3”, “5”, “8”, . . . which belong to “automobile” of (category ID=1) are outputted.

The advertisement IDs whose category belong to “automobile” are sent to banner database 41. From banner database 41, for example, three pieces of the advertising screen information of advertisement IDs whose category belongs to “automobile” are selected. Three pieces of the advertising screen information of advertisement ID, for example, “3”, “5”, and “8”, are selected and outputted and sent to advertising area information generating section 43.

At advertising area information generating section 43, information for displaying advertising area 12 is generated based on the advertising screen information sent from banner database 41. The advertising area display information generated at this advertising area information generating section 43 is sent from transmission/receiving section 47 of advertisement delivery server 1 to user's client terminal 4 via Internet (Process PRC 6). In addition, there are cases in which process PRC5-3-1 is not executed independently and process PRC 5-3-1 is included in process PRC 6.

Browser 31 of client terminal 4 generates a screen of an advertising area by hyperlink by HTTP protocol when advertising area display information described in the hyperlink language is received and allows it to be displayed at display section 33. By this, at display section 33, banner advertising images which belong to “automobile” category only are projected.

Now, when reload button 15 is clicked to update the advertisement, category ID is read from category ID storing section 61. In category ID storing section 61, as shown in FIG. 27, (category ID=1) is stored, and (category ID=1) is sent from client terminal 4 to advertisement delivery server 1.

At category ID acquisition section 46, category ID is acquired. The acquired category ID is sent to category ID/advertisement ID database 42. For example, if (category ID=1) is acquired at category ID acquiring section 46, (category ID=1) that shows the “automobile” category is sent from category ID acquiring section 46 to category ID/advertisement ID database 42.

When (category ID=1) is sent to category ID/advertisement ID database 42, from category ID/advertisement ID database 42, advertisement IDs of “3”, “5”, “8”, . . . whose category belongs to “automobile” are outputted. This advertisement IDs are sent to banner database 41. From banner database 41, advertising screen information of three advertisement IDs other than “3”, “5”, and “8” extracted before from advertisement IDs of “3”, “5”, “8”, . . . whose category belongs to “automobile” are extracted and outputted.

For example, three advertising screen information which belong to this “automobile” category are sent from banner database 41 to advertising area information generating section 43. Advertising area information generating section 43 generates advertising area display information for displaying advertising area 12 containing advertising screen information taken out from banner database 41. The advertising area display information generated at this advertising area information generating section 43 is sent from transmission/receiving section 47 of advertisement delivery server 1 to user client terminal 4 via Internet 5.

When browser 31 of client terminal 4 receives the advertising area display information described in hyperlink language, browser 31 generates a screen of advertising area and allows it to be displayed at display section 33. By this, in the sections of banner image 13a, 13b, 13c, images of new banner advertisement that belongs to “automobile” category only are projected.

### FIFTH EMBODIMENT

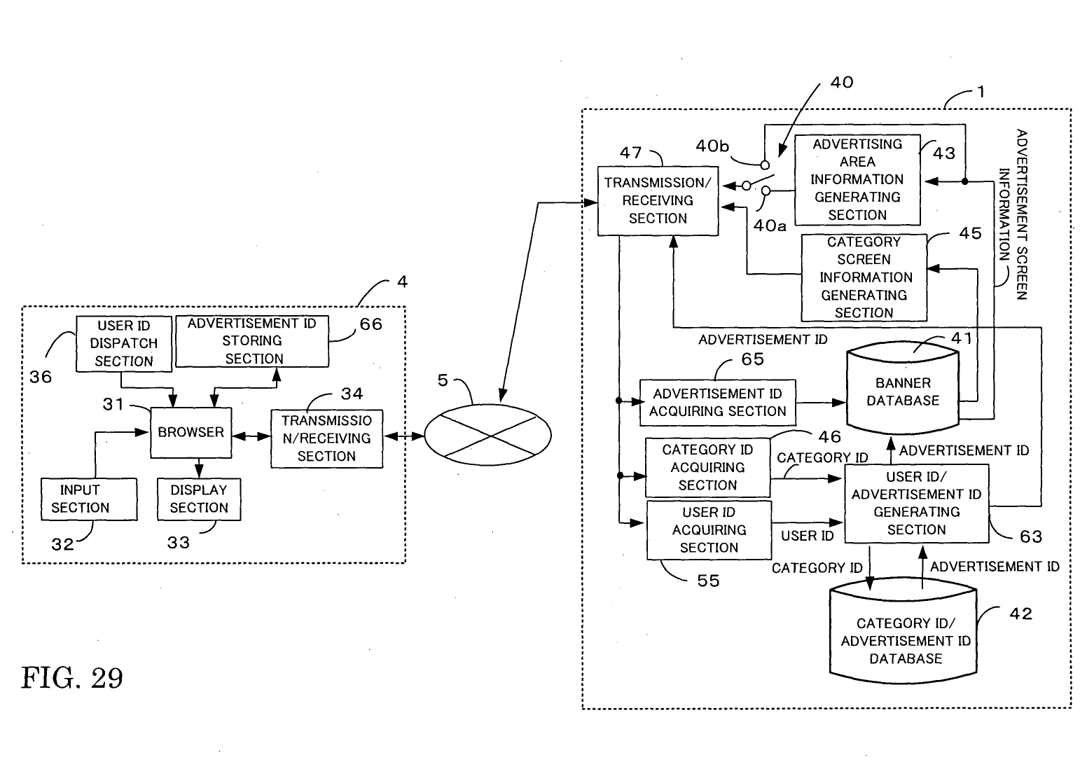

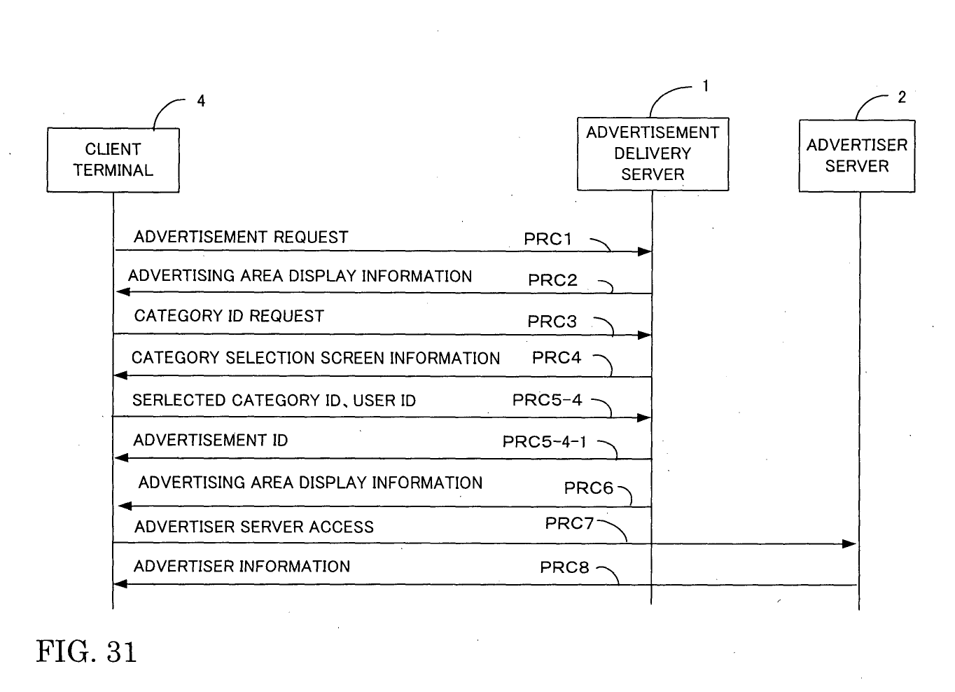

FIG. 29 is a functional block diagram showing a configuration of the fifth embodiment of the present invention, and FIG. 31 is a sequence diagram showing the operation. In the fourth embodiment previously described, category ID storing section 61 is provided at client terminal 4, and in this category ID storing section 61, the category ID which the user selected is stored. As against this, in the fifth embodiment, in client terminal 4, advertisement ID storing section 66 is stored and in this advertisement ID storing section 66, the advertisement IDs which belong to the category the user selected are stored.

On the advertisement delivery server 1 side, user ID/advertisement ID generating section 63 is installed for generating information that shows the correspondence between user ID for each user to advertisement IDs that belong to category which the user selected from user name and selected category IDs while referring to category ID/advertisement ID database 42.

When the category selection screen information from advertisement delivery server 1 is received at client terminal 4, on display section 33, category selection screen 16 is displayed on the basis of this category selection screen information. The user views this category selection screen 16 and selects categories which she/he is interested in. When a categories are selected on the category selection screen and transmission button 103 is clicked, selected category IDs are sent from client terminal 4 to advertisement delivery server 1. In addition, in such event, user ID from user ID dispatch section 36 is transmitted from client terminal 4 to advertisement delivery server 1 (process PRC 5-4).

Advertisement delivery server 1 receives category ID and user ID from client terminal 4. Category ID is acquired at category ID acquiring section 46 and user ID is acquired at user ID acquiring section 55. The acquired category ID and user ID are sent to user ID/advertisement ID generating section 63. As shown in FIG. 30, based on this category ID and user ID, at user ID/advertisement ID generating section 63, in reference to category ID/advertisement ID database 42, information that indicates the correspondence relation between the user ID and advertisement IDs of the category which the user selected is prepared.

For example, when (category ID=1) is sent from client terminal 4 of (user ID=1), at user ID/advertisement ID generating section 63, “1” is sent as user ID and “1” is sent as category ID. At user ID/advertisement ID generating section 63, referring to category ID/advertisement ID database 42, advertisement IDs whose category ID is “I” are searched. As shown in FIG. 13, the advertisement IDs concerning “automobile” of (category ID=1) is “3”, “5”, “8”, . . . Consequently, as shown in FIG. 30, for the advertisement IDs of user name (SUZUKI), information of advertisement IDs of “3”, “5”, “8”, . . . . is generated. The generated advertisement ID information is returned to client terminal 4 (process PRC 5-4-1) and stored in advertisement ID storing section 66 of client terminal 4 and at the same time, sent to banner database 41.

When advertisement IDs of “3”, “5”, “8”, . . . are sent to banner database 41, from banner database 41, for example, 3 advertising screen information whose category belongs to “automobile” are extracted. The advertising screen information of three advertisement IDs of, for example, “3”, “5”, and “8” are extracted and outputted. These three advertising screen information are sent to advertising area information generating section 43. In advertising area information generating section 43, the advertising area display information for displaying advertising area 12 is generated. This advertising area display information is sent from transmission/receiving section 47 of advertisement delivery server 1 to user's client terminal 4 via Internet 5 (process PRC 6). In addition, in such event, there are cases in which the former process PRC 5-4-1 is not executed independently but process PRC 5-4-1 is included in process PRC 6.

Browser 31 of client terminal 4 generates a screen of advertising area by hyperlink by HTTP protocol when it receives the advertising area display information described in the hyperlink language. By this, at display section 33, images of banner advertisements whose category belongs “automobile” only are projected.

Now, when reload button 15 is clicked to update advertisements, the advertising screen information whose advertisement Ids are “3”, “5”, “8”, . . . from advertisement ID storing section 66 is sent from client terminal 4 to advertisement delivery server 1.

These advertisement Ids are acquired at advertisement ID acquiring section 65. By advertisement ID acquiring section 65, as information of client terminal 4, advertisement IDs of “3”, “5”, “8”, . . . are acquired. The advertisement IDs of “3”, “5”, “8”, whose category belongs to “automobile” are sent to banner database 41.

From banner database 41, of the advertising screen information whose category belongs to “automobile”, advertising screen information of three advertisement IDs other than, for example, “3”, “5”, and “8” extracted before are extracted and outputted. The advertising screen information of the extracted three advertisement IDs are sent to advertising area information generating section 43.

At advertising area information generating section 43, advertising area display information for displaying advertising area 12 is generated based on the advertising screen information sent from banner database 41. The advertising area display information generated at this advertising area information generating section 43 is sent from transmission/receiving section 47 of advertisement delivery server 1 to user's client terminal 4 via Internet 5.

Browser 31 of client terminal 4 generates a screen of advertising area by hyperlink by HTTP protocol when it receives the advertising area display information described in the hyperlink language and allows it to be displayed at display section 33. By this, at the portion of banner images 13a, 13b, 13c, images of new banner advertisements which belong to the “automobile” category are projected.

Because as described above, in the second embodiment and the fourth embodiment, category ID is stored for each user, while in the third embodiment and the fifth embodiment, advertisement IDs are stored for each user, every time reload button 15 is clicked and advertising screen information is updated, new banner advertisement which belongs to the selected category is displayed. In addition, when the advertisement is displayed next time, banner advertisement of the category of the user's interest is displayed even if the user does not select the category.

When the banner advertisement is updated, any advertising screen information may be extracted from the advertising screen information which belongs to the same category, but when reload button 15 is clicked and the advertising screen information is updated, it is general practice to extract the advertising screen information different from the previous time. And when all the advertising screen information whose category belongs to “automobile”, the system returns to the beginning and the advertising screen information is extracted. The priority further may be given to advertisement information in accordance with advertisement rates and advertising screen information may be delivered sequentially.

In addition, in the above-mentioned example, for example, three pieces of advertising screen information are extracted on the banner database but a plurality of advertisement information may be dispatched en bloc to the client terminal 4 side at one time. Then the advertising screen information may be successively selected from them and displayed on the client terminal 4.

By the way, in this case, reload button 15 is clicked to update advertisements, but needless to say, advertisements may be updated by the use of the update button of the browser. However, when the browser update button is used, the whole screen of advertising area 12 is updated, and banner images 13a, 13b, 13c portions only cannot be updated.

In addition, in the above-mentioned example, three pieces of advertising screen information of banner advertisement are selected to be displayed on advertising area 12, but needless to say, this is not restricted to these three. In addition, the form and the size of banner advertisement may be varied individually. Furthermore, banner advertisement may be automatically updated without using any reload button 15 or browser update button. The automatic update program may be provided on the advertisement delivery server 1 side or may be provided on the client terminal 4 side.

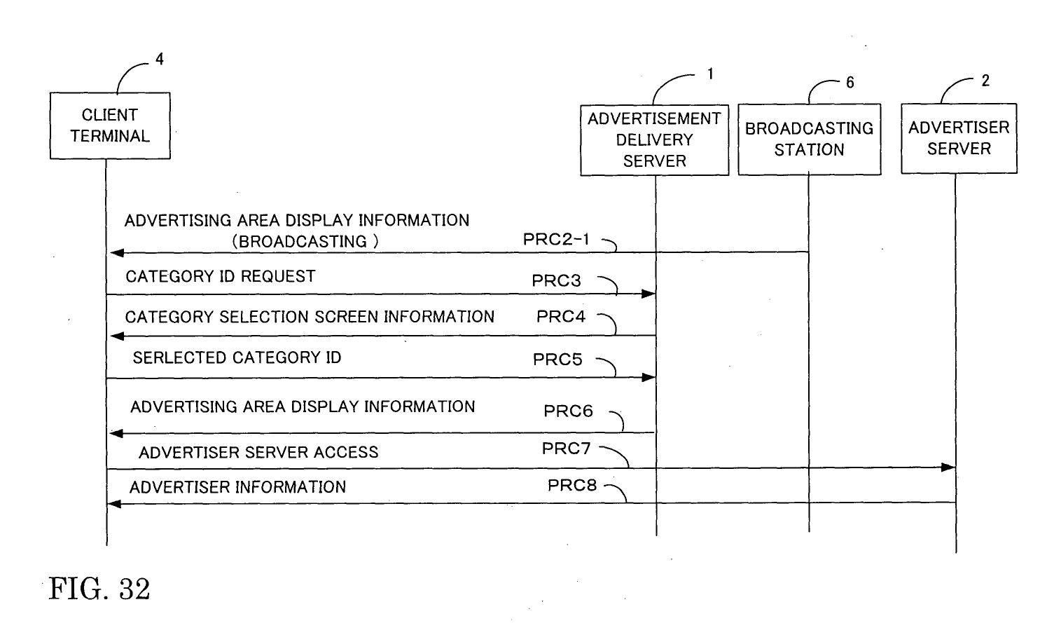

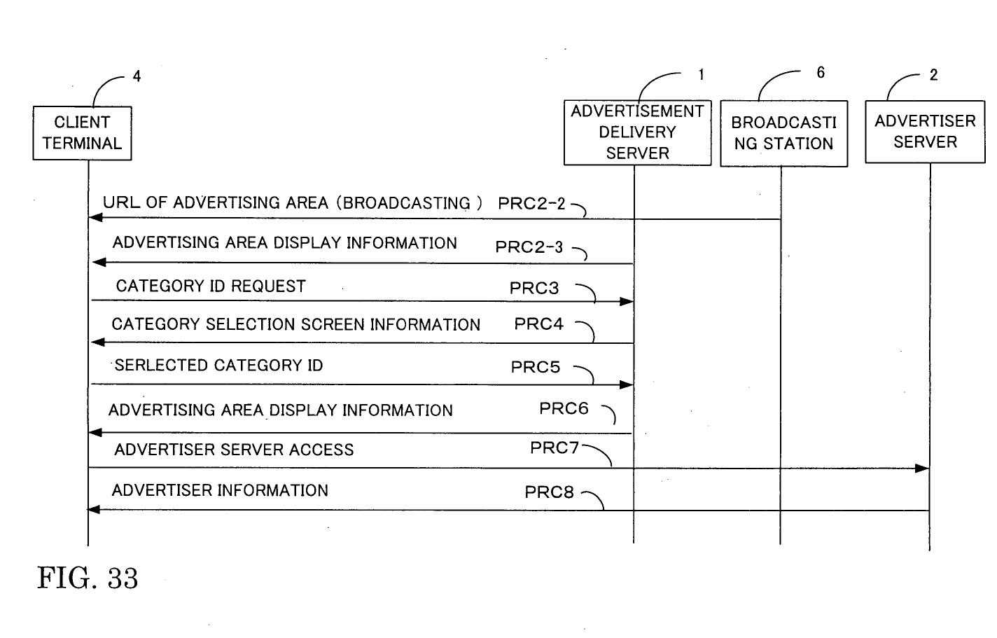

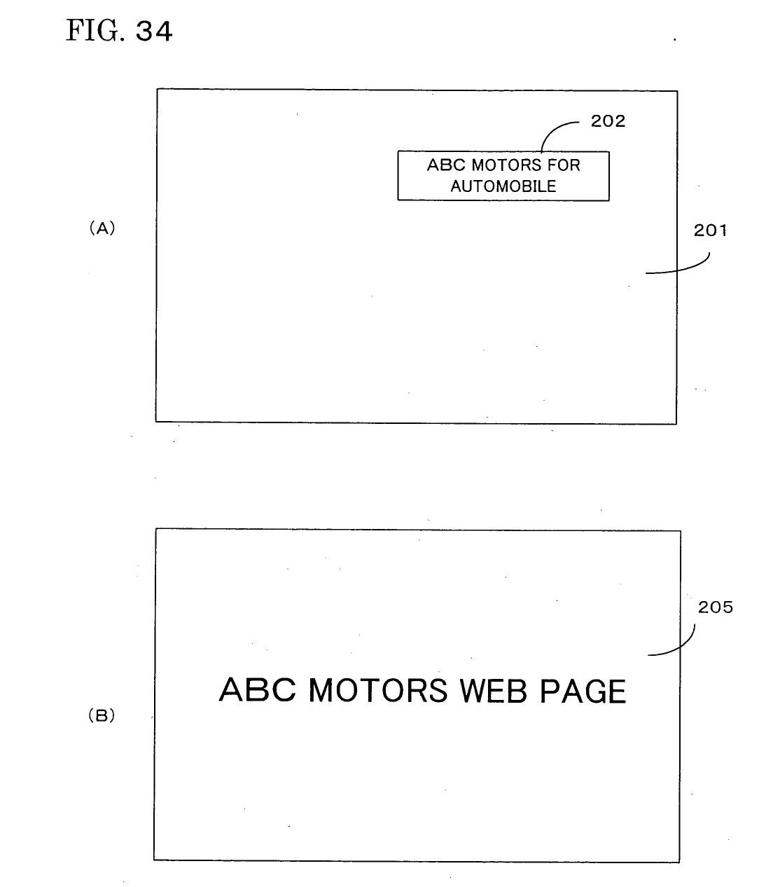

In addition, in the above-mentioned example, banner advertising on Internet is explained but the present invention can be applied similarly to the case of linkage communication of digital broadcasting and Internet in which the advertising area display information is sent to the client terminal by digital broadcasting for the first time, the banner image is displayed in the advertising area of the client terminal, and then, using Internet, communication is carried out between advertisement delivery server and client terminal. FIG. 32 and FIG. 33 are the sequence diagram in such event. In FIG. 32, the advertisement request sent from client terminal 4 to advertisement delivery server 1 in FIG. 10 is eliminated, and the advertising area display information is sent from a broadcast station 6 to client terminal 4 by broadcasting (process PRC 2-1), client terminal 4 receives it, advertising area 12 is allowed to be displayed on display section 33 based on the advertising area display information, and the user presses category selection button 14 of advertising area 12 to change over communication from the stage for sending a category ID request to advertisement delivery server 1 (process PRC 3) to communication via Internet.

In FIG. 33, the advertisement request sent from client terminal 4 to advertisement delivery server 1 in FIG. 10 is eliminated, and the URL of the advertising area is sent from a broadcast station 6 to client terminal 4 by broadcasting (process PRC 2-2), then based on the URL of the advertising area, the advertising area display information is sent from the advertisement delivery server 1 to the client terminal 4 via Internet (process PRC 2-3). By user's selecting the category name displayed in the advertising area, a category ID request is sent from client terminal 4 to advertisement delivery server 1 (process PRC 3).

In the above-mentioned example, the advertisement delivery server may not always be located at one place but a system may be configured by linking machines distributed on the network.

In addition, because in the above examples, various constructions of data stored and generated in the advertisement delivery server or client terminal may be considered in addition to those described herein, other data constructions may be adopted in accordance with the environment.

The present invention should not be restricted to the above-mentioned embodiments but forms of the above embodiments may be combined and arranged. In addition, the present invention should not be restricted to the above-mentioned embodiments but various changes and applications should be allowed without departing from the spirit and the scope of the present invention.

1. An advertisement delivering method for displaying advertising screen information, with information on an advertiser's web page to be linked embedded in the screen, comprising:
an advertisement delivery server that transmits advertising area display information for displaying an advertising area containing advertising screen information on a client terminal and, at the same time, transmits category selection screen information for selecting advertisement categories,
a client terminal that receives the advertising area display information from the advertisement delivery server, displays the advertising area containing the advertising screen information based on the advertising area display information received, and, at the same time, displays a category selection screen based on the category selection screen information received, and transmits category information selected to the advertisement delivery server when any category is selected at the category selection screen, wherein
the advertisement delivery server receives, from the client terminal, the category information selected, extracts the advertising screen information that belongs to the category selected based on the category information selected, and sends the advertising screen information to the client terminal, and
the client terminal receives the advertising screen information that belongs to the category selected and updates the advertising screen information in the advertising area based on the advertising screen information received.

2. The advertisement delivery method according to claim 1 wherein the category selection screen is displayed by pressing a control button displayed on the advertising area.

3. The advertisement delivery method according to claim 1 wherein relevant information is derived from the category information selected and is stored in the advertisement delivery server.

4. The advertisement delivery method according to claim 1 wherein relevant information is derived from the category information selected and is stored in the client terminal.

5. The advertisement delivery method according to claim 3 wherein the relevant information is a relation between the user information and the category information selected.

6. The advertisement delivery method according to claim 3 wherein the relevant information is generated based on a relation between the user information and the advertising screen information that belongs to the category selected.

7. The advertisement delivery method according to claim 4 wherein the relevant information is a relation between the user information and the category information selected.

8. The advertisement delivery method according to claim 4 wherein the relevant information is generated based on a relation between the user information and the advertising screen information that belongs to the category selected.

9. The advertisement delivery method according to claim 1 wherein the advertising area is updated by updating all of the advertising areas including the advertising screen information.

10. The advertisement delivery method according to claim 1 wherein the advertising area is updated by updating a portion of the advertising screen information in the advertising area including the advertising screen information.

11. An advertisement delivery system for displaying advertising screen information, with information of an advertiser's web page to be linked embedded in the screen, comprising:
an advertisement delivery server comprising a delivered advertising screen information storage section for storing advertising screen information consisting of an advertising image and an advertiser's web page information to be linked embedded in the advertising image, and information showing a relation between an advertisement category and the advertising screen information belonging to the advertisement category, an advertising area information generating section for generating advertising area display information, and a category screen information generating section for generating category selection screen information,
a client terminal comprising a display section for displaying an advertising area containing the advertising screen information based on the advertising area display information received from the advertisement delivery server and, at the same times for displaying a category selection screen based on category selection screen information received from the advertisement delivery server, and an input section for selecting the category, and
a network for connecting the advertisement delivery server to the client terminal, wherein
the advertisement delivery server transmits the advertising area display information for allowing the client terminal to display an advertising area containing advertising screen information and, at the same time, transmits the category selection screen information for allowing the client terminal to display a category selection screen,
the client terminal receives the advertising area display information from the advertisement delivery server, displays the advertising area containing the advertising screen information based on the advertising area display information received and, at the same time, receives the category selection screen information from the advertisement delivery server, displays the category selection screen based on the category selection screen information received, and transmits category information selected to the advertisement delivery server when any category is selected from the category selection screen,
the advertisement delivery server receives the category information selected from the client terminal, extracts the advertising screen information that belongs to the category selected, and transmits the advertising screen information to the client terminal, and
the client terminal receives the advertising screen information that belongs to the category selected and updates the advertising screen information in the advertising area.

12. An advertisement delivery server of an advertisement delivery system in which advertising screen information, with information of the advertiser's web page to be linked embedded in the screen, is displayed in the screen, comprising:
a delivered advertising screen information storage section for storing advertising screen information consisting of an advertising images and the advertiser's web page to be linked embedded in the advertising images and information showing a relation between an advertisement category and the advertising screen information belonging to the advertisement category,
an advertising area information generating section for generating advertising area display information, and
a category screen information generating section for generating category selection screen information, wherein
the advertising area display information for displaying an advertising area containing the advertising screen information is transmitted to a client terminal and at the same times category selection screen information for displaying a category selection screen is transmitted to the client terminal, and
the advertising screen information that belongs to category information selected is extracted and transmitted to the client terminal based on the category information selected when the category information selected is received from the client terminal.

13. The advertisement delivery server according to claim 12 including a category information storage section for storing user information and corresponding category information selected.

14. The advertisement delivery server according to claim 12 including an advertising screen information storage sections for storing user information and corresponding advertising screen information that belongs to the category selected.

15. A client terminal comprising:
a display section for displaying a screen of an advertising area containing advertising screen information as well as displaying a category selection screen, and
an input section for selecting a category, wherein
when advertising area display information for displaying an advertising area containing advertising screen information is received from an advertisement delivery server, the advertising area containing the advertising screen information is displayed based on the advertising area display information received,
when category selection screen information for displaying a category selection screen is received from the advertisement delivery server, a category selection screen is displayed based on the category selection screen information received,
when categories are selected by the input section, the category information selected is transmitted to the advertisement delivery server, and
when advertising screen information that belongs to the categories selected is received from the advertisement delivery server, the advertising screen information in the advertising area is updated.

16. The client terminal according to claim 15 including a category information storage section for storing the category information selected.

17. The client terminal according to claim 15 including an advertising screen information storage section for storing the advertising screen information that belongs to the category selected.
